(19) United States
(12) Patent Application Publication
(10) Pub. No.: US 2026/0289272 A1
(43) Pub. Date: Sep. 24, 2026

(54) SYSTEM

(71) Applicant: SoftBank Group Corp., Tokyo (JP)

(72) Inventor: Genki WATABE, Tokyo (JP)

(73) Assignee: SoftBank Group Corp., Tokyo (JP)

(21) Appl. No.: 19/567,024

(22) Filed: Mar. 14, 2026

(30) Foreign Application Priority Data
Mar. 19, 2025 (JP) 2025-045221

(51) Int. Cl. G06N 3/0475; G06F 16/242

(52) U.S. Cl. CPC G06N 3/0475; G06F 16/242

(57) ABSTRACT

A system includes a processor that is configured to collect player data and video, and store the collected player data and video in a database, input the collected player data and video to a generative AI model and perform analysis by using a prompt that instructs the generative AI model to evaluate an ability and a potential of a player, and support a scouting decision of a scout and present optimal player options based on an analysis result obtained by the AI.

### CROSS-REFERENCE TO RELATED APPLICATION

This application is based on and claims priority under 35 USC 119 from Japanese Patent Application No. 2025-045221 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional scouting support systems mainly rely on manual analysis of player performance data and video by human scouts, which is time-consuming, subjective, and limited in scalability. Even when AI-based analytics are employed, such systems often use fixed algorithms that do not fully leverage generative AI models, and therefore have limited flexibility in terms of how players'abilities and potentials are evaluated and how scouting decisions are supported. Furthermore, existing systems generally lack a mechanism to systematically generate and adjust numerical evaluation scores and candidate options based on rich, unstructured inputs such as video data and contextual information, and they do not incorporate emotion-adjustment or similar meta-evaluation to refine the final candidate presentation. As a result, it is difficult to efficiently and objectively identify and present optimal player options to scouts from a large pool of players. Accordingly, there is a need for a system that uses prompts to control generative AI models so as to evaluate player abilities and potentials from collected player data and video, numerically quantify such evaluations, and support and refine scouting decisions, thereby enabling efficient and accurate presentation of optimal player options.

### SUMMARY

In order to solve the above-described problems, according to one aspect of the present invention, there is provided a system comprising a processor, wherein the processor is configured to collect player data and video, and store the collected player data and video in a database, input the collected player data and video to a generative AI model and perform analysis by using a prompt that instructs the generative AI model to evaluate an ability and a potential of a player, and support a scouting decision of a scout and present optimal player options based on an analysis result obtained by the AI. In one embodiment, the processor is further configured to numerically quantify the ability and the potential of the player from performance data and video of the player, and generate an evaluation score by performing analysis on the generative AI model by using a prompt that instructs the generative AI model to perform an ability evaluation of the player. In another embodiment, the processor is further configured to present the optimal player options based on the analysis result obtained by the AI and an emotion-adjustment result obtained by an emotion engine, by evaluating and presenting the options using data obtained from the generative AI model and by using a prompt that instructs evaluation and presentation of the options. Through these configurations, the system utilizes prompt-controlled generative AI analysis, numerical scoring, and emotion-adjusted option evaluation to efficiently support scouting decisions and accurately present optimal player options.

The term “system” refers to an integrated arrangement of hardware and software components including at least one processor, memory, storage, and communication interfaces, configured to execute the functions recited in the claims.

The term “processor” refers to one or more hardware processing units, such as a central processing unit (CPU), graphics processing unit (GPU), or specialized accelerator, that executes instructions to perform the operations described in the claims.

The term “player” refers to an individual athlete, such as a professional, semi-professional, or amateur sports participant, whose performance, ability, or potential is to be evaluated.

The term “player data” refers to structured or unstructured information related to a player, including but not limited to performance statistics, biometric information, positional data, match records, and profile information.

The term “video” refers to digital video data including moving images, optionally with audio, that depict a player's actions during training sessions, matches, or other relevant activities.

The term “database” refers to a storage system, which may be relational, non-relational, or any other structured data store, in which player data and video, or related metadata, are stored and managed.

The term “generative AI model” refers to an artificial intelligence model, such as a large language model or other generative model, that is capable of generating or transforming data, including textual evaluations or numerical outputs, in response to input data and prompts.

The term “prompt” refers to a command, instruction, or query, expressed in natural language or another representation, that is supplied to the generative AI model in order to cause the generative AI model to perform a specific analysis or generation task.

The term “ability” refers to a current performance capability of the player, including technical, physical, tactical, or mental aspects relevant to the player's performance in a sport.

The term “potential” refers to a predicted or estimated future performance capability or growth capacity of the player, based on current data, trends, or model inferences.

The term “analysis” refers to processing performed by the generative AI model on input player data and video in accordance with the prompt, including evaluating, inferring, generating, or transforming information related to the player's ability or potential.

The term “analysis result” refers to an output produced by the generative AI model in response to a prompt and input data, including textual evaluations, numerical scores, rankings, or other derived information.

The term “scouting decision” refers to a decision or judgment made by a scout or scouting organization regarding actions such as recruiting, signing, promoting, or further observing a player.

The term “scout” refers to a person or organization responsible for identifying, evaluating, and recommending players for a team or other sports entity.

The term “optimal player options” refers to one or more players, selected or ranked from a group of candidates, who are determined by the system to best satisfy specified scouting criteria based on the analysis result.

The term “performance data” refers to data representing the actions or outcomes associated with a player's performance in games or training, including numerical and categorical metrics such as goals, assists, distance covered, minutes played, or similar indicators.

The term “numerically quantify” refers to the operation of converting qualitative or heterogeneous information about a player's ability or potential into one or more numerical values.

The term “evaluation score” refers to a numerical value or set of values computed to represent at least one aspect of a player's ability or potential, which can be used for comparison, ranking, or selection among multiple players.

The term “emotion engine” refers to a component, implemented in software and/or hardware, that performs emotion-related processing to generate an emotion-adjustment result, for example by modeling human emotional responses, preferences, or biases with respect to players or analysis results.

The term “emotion-adjustment result” refers to a result generated by the emotion engine that adjusts, weights, or modifies the analysis result or candidate evaluation based on emotion-related factors, such as preferences, enthusiasm, risk tolerance, or perceived fit.

The term “options” refers to candidate players or candidate sets of players that are subject to evaluation and possible presentation to a scout for selection or further consideration.

The term “evaluation and presentation of the options” refers to the operations of assessing candidate players using data obtained from the generative AI model and then generating information, such as rankings, lists, or summaries, to be output to a user interface for use by a scout.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

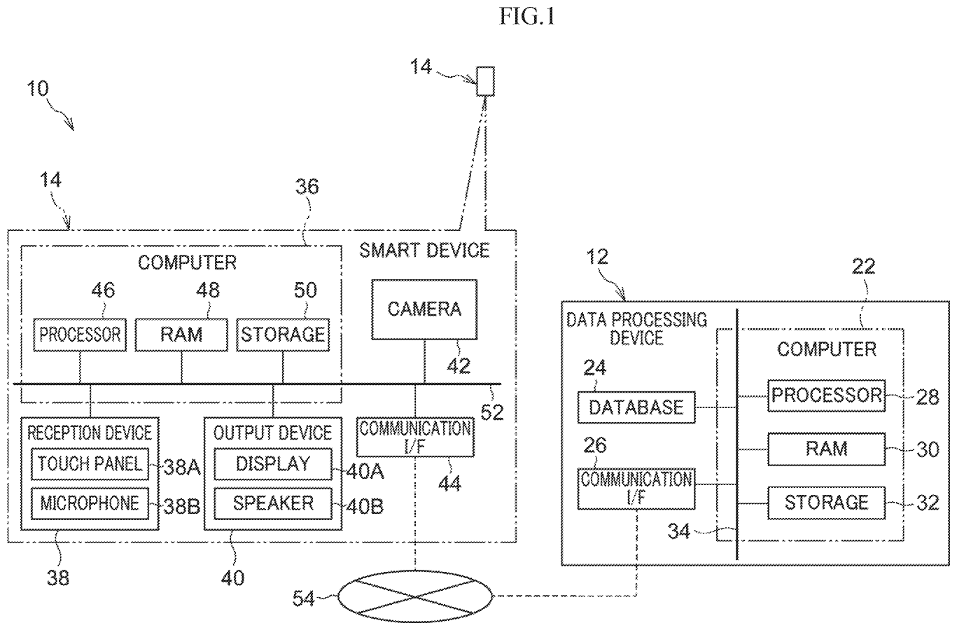

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

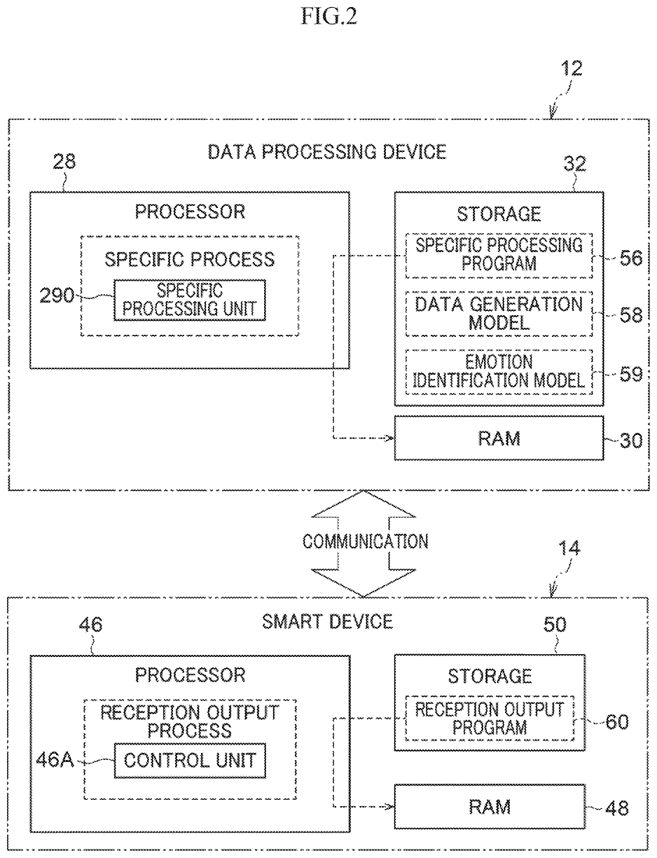

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented scouting and candidate selection systems for competitive activities typically treat heterogeneous data sources, such as structured performance logs and unstructured image or video data, as independent information channels. Processing pipelines in these systems are often fragmented, with separate modules for data acquisition, statistical computation, and report generation, and with only limited coordination between such modules. As a result, these systems frequently suffer from sub-optimal utilization of available computing resources and under-exploitation of complex correlations present across different data modalities.

In particular, known systems generally perform rule-based or model-specific scoring on preprocessed numerical data, and then present fixed summaries to a user. Such systems are not designed to leverage generative artificial intelligence models as central computational components that operate directly over unified feature representations derived from both structured and unstructured data. Moreover, these systems do not provide a programmable interface, in the form of dynamically generated prompt sentences, that allows a processor to systematically control the behavior of a generative artificial intelligence model for different computational tasks such as performance evaluation, candidate ranking, and interactive re-querying. Consequently, existing approaches exhibit limitations in adaptability, extensibility, and responsiveness to user-driven queries, and are prone to increased latency and redundant computations when handling iterative decision-making workflows.

Additionally, when users attempt to refine candidate sets or request explanations, conventional systems often rely on ad hoc query logic implemented in application code or database queries. This tends to replicate computations, fail to reuse intermediate evaluation results, and provide shallow or non-transparent explanations. There is insufficient technical integration between the user's natural-language input and the internal evaluation pipeline, resulting in inefficient use of processor cycles and memory, as well as an inability to consistently generate context-aware, data-grounded responses.

Accordingly, there is a need for an improved computer-implemented system and server-side processing architecture that: (i) unifies structured performance information and image-based information into coordinated feature sets using systematic preprocessing and feature extraction, (ii) controls a generative artificial intelligence model through explicitly constructed prompt sentences for different internal computational roles, and (iii) reuses evaluation information in response to user-supplied prompt sentences to dynamically update candidate groups, rankings, and explanatory outputs. Such an improvement should enhance the efficiency, scalability, and flexibility of the underlying computer system, reduce redundant computations, and improve the quality and consistency of interactive decision support provided to the user.

The specific processing by the specific processing unit 290 of the data processing device 12 in Example 1 is realized by the following means.

The present invention provides a server comprising a processor and a storage device, the processor being configured to acquire participant information related to a competitive activity from one or more external information sources and store the participant information in the storage device; to perform, on the participant information stored in the storage device, preprocessing including missing-value completion, normalization, aggregation, and encoding, and to generate structured feature sets including numerical feature sequences and time-series feature sequences; to extract, from image information contained in the participant information, pixel information, to perform feature extraction processing based on the pixel information, and to generate feature sets corresponding to the image information; to generate a prompt sentence that instructs a generative artificial intelligence model to perform performance-evaluation computation and preference-degree computation based on the structured feature sets and the feature sets corresponding to the image information, and to input the prompt sentence and the feature sets to the generative artificial intelligence model so as to cause the generative artificial intelligence model to generate evaluation information of participants; to select a candidate group of participants based on the evaluation information, to rank the candidate group, and to generate and transmit, to a terminal device, visualization information including the candidate group and the evaluation information; and to associate a query prompt sentence generated in response to input from a user with the evaluation information, to re-input the query prompt sentence and the evaluation information to the generative artificial intelligence model, and to cause the generative artificial intelligence model to generate explanatory information and recommendation information for assisting decision-making of the user and provide the explanatory information and the recommendation information to the terminal device. This enables improvement of computer functionality by integrating multimodal feature generation and generative artificial intelligence control into a unified server-side pipeline that reduces redundant computations, enhances the efficiency and scalability of participant evaluation and candidate selection, and provides dynamically updated, data-grounded explanations and rankings in response to user-supplied prompt sentences.

The term “participant information” refers to information related to an individual or entity taking part in a competitive activity, including but not limited to structured performance records, identification information, contextual information, and associated multimedia data such as image information or video information.

The term “competitive activity” refers to any activity in which two or more individuals or entities compete according to predetermined rules, including but not limited to sports, games, contests, and other performance-based comparisons.

The term “external information source” refers to any data provider located outside the server, including but not limited to remote databases, network-accessible application programming interfaces, data feeds, and storage services from which participant information is obtained.

The term “storage device” refers to any hardware or logical resource capable of storing data, including but not limited to semiconductor memory, magnetic storage, optical storage, and network-attached storage, as well as logical data stores implemented thereon.

The term “preprocessing” refers to a sequence of data transformation operations performed prior to model input, including but not limited to missing-value completion, normalization, aggregation, and encoding, for the purpose of converting raw participant information into structured feature representations.

The term “missing-value completion” refers to a process of identifying absent or null values in participant information and assigning substitute values based on predetermined rules, statistical estimation, or model-based inference.

The term “normalization” refers to a process of transforming numerical values into a common scale or range, such as scaling, standardization, or other mathematical transformation, so as to improve numerical stability and comparability for subsequent computation.

The term “aggregation” refers to a process of combining multiple data records into summarized values, including but not limited to averaging, summing, or computing statistics over a set of data points aggregated by participant, time period, or event type.

The term “encoding” refers to a process of converting non-numerical or categorical data into numerical representations, including but not limited to one-hot encoding, label encoding, or embedding-based encoding suitable for model input.

The term “structured feature set” refers to a collection of data elements derived from participant information that is organized into predefined formats, such as vectors, matrices, or tables, and is suitable for numerical processing by a computing model.

The term “numerical feature sequence” refers to an ordered set of numerical values representing characteristics of a participant, such as performance metrics or contextual indicators, arranged in a predetermined order.

The term “time-series feature sequence” refers to a sequence of numerical feature vectors indexed or ordered by time, representing the evolution of participant characteristics or performance over multiple time points or events.

The term “image information” refers to digital information representing visual content, including but not limited to still images, video frames, or sequences of frames, from which pixel information may be obtained.

The term “pixel information” refers to numerical values corresponding to individual picture elements or groups of picture elements that constitute image information, including but not limited to intensity values, color values, and derived spatial features.

The term “feature extraction processing” refers to a computation that converts raw data, such as pixel information, into higher-level features or descriptors that capture patterns, structures, or attributes relevant for subsequent analysis.

The term “feature set corresponding to the image information” refers to a collection of features computed from image information, such as vectors or other numerical representations, which describe visual characteristics associated with a participant.

The term “generative artificial intelligence model” refers to a computational model configured to generate outputs, including but not limited to numerical values, text, or other data structures, based on input data and a prompt sentence, and may include models based on machine learning, neural networks, or probabilistic generative mechanisms.

The term “prompt sentence” refers to data, typically expressed as a textual or token sequence, that specifies instructions, conditions, or context and is provided as input to a generative artificial intelligence model in order to control or influence the behavior of the model.

The term “performance-evaluation computation” refers to a computation performed by or under the control of a generative artificial intelligence model to estimate one or more performance characteristics of a participant based on feature sets and instructions contained in a prompt sentence.

The term “preference-degree computation” refers to a computation performed by or under the control of a generative artificial intelligence model to determine one or more values indicating relative suitability, desirability, or ranking of a participant with respect to one or more criteria.

The term “evaluation information” refers to information generated by a generative artificial intelligence model that quantifies or describes characteristics of a participant, including but not limited to scores, indices, rankings, or textual assessments.

The term “candidate group of participants” refers to a subset of participants selected from a larger population based on evaluation information or other criteria, and considered as candidates for a particular purpose such as recruitment, selection, or recommendation.

The term “ranking” refers to an ordering of elements, such as participants in a candidate group, according to one or more values, such as evaluation scores or composite indices, so that relative positions can be determined.

The term “visualization information” refers to data that represents evaluation information or candidate groups in a form suitable for display, including but not limited to chart data, graph configurations, graphical representations, and associated labels or annotations.

The term “terminal device” refers to any computing apparatus used by a user to access, receive, and display information from the server, including but not limited to a personal computer, a mobile device, a tablet device, or a display terminal.

The term “query prompt sentence” refers to a prompt sentence generated based on input from a user that specifies a query, refinement request, or explanatory request to be processed by a generative artificial intelligence model.

The term “explanatory information” refers to information generated by a generative artificial intelligence model that provides explanations, reasons, or justifications related to evaluation information, candidate selection, or ranking.

The term “recommendation information” refers to information generated by a generative artificial intelligence model that suggests one or more participants or actions to a user, based on evaluation information, user conditions, or other criteria.

The term “integrated input information” refers to a combined data structure that includes at least a query prompt sentence, evaluation information, and information related to a candidate group of participants, which is provided as input to a generative artificial intelligence model.

The term “response information” refers to information output by a generative artificial intelligence model in response to integrated input information, including but not limited to candidate reselection results, ranking modification results, and rationale explanations.

The term “current-performance index” refers to a numerical value that represents an estimated current performance level of a participant, computed based on structured feature sets and, optionally, feature sets corresponding to image information.

The term “future-growth index” refers to a numerical value that represents an estimated future performance potential or growth capacity of a participant, computed based on structured feature sets and, optionally, feature sets corresponding to image information.

The term “role-suitability index” refers to a numerical value that represents an estimated suitability of a participant for a particular role, function, or style within a competitive activity, computed based on structured feature sets and, optionally, feature sets corresponding to image information.

The term “composite evaluation index” refers to a numerical value computed by combining two or more numerical evaluation values, such as a current-performance index, a future-growth index, and a role-suitability index, according to a predetermined rule or model.

In one embodiment, a server, a terminal, and a user cooperate to implement a system for evaluating participants in a competitive activity by using a generative AI model controlled via prompt sentences. The server executes computer programs stored in a non-transitory computer-readable medium and performs coordinated data acquisition, preprocessing, feature generation, model inference, and response generation. The terminal executes a client application that presents visualization information, receives user input, and transmits query prompt sentences to the server. The user operates the terminal to define conditions, review evaluation information, and refine candidate groups.

The server uses hardware such as a processor, a main memory, a network interface, and a storage device. The processor may be a multi-core general-purpose central processing unit, a graphics processing unit, or a combination thereof. The storage device may be implemented using a solid-state drive or a magnetic disk drive, and may store participant information databases, model parameters, and log data. The server runs an operating system and middleware including a web server, an application server, and a database management system. The server may execute data processing software implemented in a general-purpose programming language such as Python or a similar interpreted language, and may use software libraries such as numerical computation libraries, data analysis libraries, and machine learning frameworks, for example a machine learning framework such as a tensor-based framework or a dynamic computation-graph framework.

The terminal may be a smartphone, a tablet device, a laptop computer, or a desktop computer. The terminal includes a processor, a memory, a display device, an input device, and a network interface. The terminal runs a web browser or a native application. The terminal renders charts, tables, and textual information based on visualization information received from the server. The terminal also captures user actions, such as selection of filters and entry of a prompt sentence, and transmits the corresponding data to the server through a communication network such as the Internet.

The server acquires participant information from one or more external information sources. The external information sources may include remote relational databases, network-accessible application programming interfaces, or file storage services. The server uses a database client library to issue SQL queries to relational data sources and uses an HTTP client library to send HTTP requests to application programming interfaces. The server receives structured data, such as tabular records of performance metrics, and unstructured data, such as image information or video streams. The server stores the received data in the storage device in a predetermined database schema and file hierarchy.

The server performs preprocessing on the participant information stored in the storage device. The server uses a data analysis library to load records into in-memory data structures such as data frames. The server executes missing-value completion by scanning each column of the data frame and computing replacement values such as means, medians, or regression-based estimates. The server performs normalization by transforming numerical features, for example by subtracting a mean and dividing by a standard deviation, or by applying min-max scaling to a predetermined range. The server executes aggregation by grouping records by participant and time period and computing aggregate statistics such as averages per unit time or cumulative totals. The server performs encoding by converting categorical attributes, such as role or league, into numerical vectors using one-hot encoding or similar schemes. As a result, the server generates structured feature sets that include numerical feature sequences and time-series feature sequences for each participant.

The server processes image information contained in the participant information to generate feature sets corresponding to the image information. The server uses a multimedia processing library to decode image information such as video files into pixel information. The server samples frames at predetermined intervals or around detected events and converts them into tensors representing pixel intensities and color channels. The server inputs the pixel tensors to a feature extraction network, for example a convolutional neural network, that has multiple convolutional layers, pooling layers, and fully connected layers. The server obtains intermediate activation vectors from one or more layers and treats these activation vectors as visual embeddings. The server aggregates these embeddings across time, for example by temporal averaging or by an attention mechanism, to form fixed-length feature vectors representing visual characteristics associated with each participant. These vectors constitute feature sets corresponding to the image information.

The server integrates the structured feature sets and the feature sets corresponding to the image information into unified model inputs. In one embodiment, the server concatenates numerical feature sequences and visual embeddings to form multimodal feature vectors. In another embodiment, the server uses separate encoders for numerical features and visual features, and then combines their outputs in a joint representation space. The server stores the resulting feature sets in a feature store on the storage device, indexed by participant identifier and time.

The server uses a generative AI model to generate evaluation information. In one embodiment, the generative AI model has a transformer-based neural network architecture. The server loads model parameters from the storage device into memory. The model includes an embedding layer that maps tokens of a prompt sentence into embedding vectors, positional encoding applied to those vectors, a plurality of multi-head self-attention layers, feed-forward layers, and a final output projection layer. The server extends the model inputs by injecting numerical and visual features into the model input sequence. For example, the server converts elements of the structured feature sets and image-derived feature sets into tokens or low-dimensional vectors and aligns them with the text tokens using a predefined tokenization and embedding scheme. The server then feeds the combined sequence into the transformer network.

The server controls the behavior of the generative AI model by constructing explicit prompt sentences. The server generates a prompt sentence that instructs the model to perform performance-evaluation computation and preference-degree computation, given the features.

For example, the server may generate a prompt sentence such as:
“You are a model that evaluates participants in a competitive activity. Using the feature vectors and time-series statistics provided, calculate for each participant a current performance score, a future growth score, and a role suitability score, each on a scale from 0 to 100. Then compute an overall composite evaluation score and rank the participants by this composite score.”

The server may embed numerical tables or serialized representations of the structured feature sets and feature sets corresponding to the image information following the prompt sentence in a predefined textual format. The server encodes this combined input using the tokenizer associated with the generative AI model, generating discrete tokens that correspond to both instruction text and data values.

The server executes forward propagation of the generative AI model on the processor and optionally on an attached graphics processing unit. The processor computes attention weights and hidden states layer by layer, applying matrix multiplications and non-linear activation functions. The processor uses model parameters that have been learned in advance through training. The server obtains output tokens from the model that represent numerical evaluation values and textual commentary. The server parses these tokens to obtain, for each participant, a current-performance index, a future-growth index, a role-suitability index, and an optional composite evaluation index. The server uses a parsing routine to interpret the tokens as numbers based on a predefined output format.

The server stores the obtained indices as evaluation information in the storage device. The server then selects a candidate group of participants based on the evaluation information. For example, the server may sort participants by the composite evaluation index and choose the top K participants that satisfy constraints such as an age range or a role constraint. The server records the candidate group and their ranks, and constructs visualization information that includes the evaluation information and the candidate group. The visualization information may include chart configuration data for drawing bar charts, radar charts, and line charts, as well as textual labels for each participant.

The server transmits the visualization information to the terminal. The terminal receives the visualization information through the network interface and renders corresponding charts and tables on the display device using a chart library or native drawing functions. The terminal may use color coding and graphical emphasis to highlight the top-ranked participants. The terminal also displays textual summaries and evaluation values in a structured layout.

The user observes the information displayed on the terminal and may wish to refine the candidate group or obtain explanations. The terminal provides a text input field for the user to enter a query prompt sentence. The user may input, for example, the following prompt sentence:
“Explain why the top three participants are recommended as candidates, focusing on their consistency over time and their suitability for a high-intensity role.”

In another example, the user may input a prompt sentence such as:
“Recalculate the rankings by giving more weight to long-term potential and less weight to current performance.”

The terminal sends the user-entered prompt sentence, together with identifiers of the currently displayed candidate group and relevant context, to the server.

The server receives the user's query prompt sentence and retrieves the corresponding evaluation information and candidate group from the storage device. The server constructs integrated input information that combines the query prompt sentence, the evaluation information, and candidate identifiers. The server may format the integrated input information as text, embedding structured values in a human-readable pattern that the generative AI model has been trained to interpret. The server then provides this integrated input information to the generative AI model.

The server generates a new prompt sentence to instruct the generative AI model how to use the integrated input information. For example, the server may construct: “You are a model that refines candidate rankings and generates explanations. The following section contains current evaluation scores and candidate identifiers. According to the user's request, adjust the weights of the current performance and future growth scores, recompute the composite scores, update the ranking, and provide a textual explanation of the key differences among the candidates.”

The server appends the user's query prompt sentence and the evaluation information in a structured textual layout after this instruction. The server tokenizes the entire input and passes it through the generative AI model. The server receives response information that includes, for example, updated composite indices, a new ranking order, and a paragraph-level explanation. The server parses the response information to extract structured elements and textual explanations. The server updates the candidate group and the evaluation information in the storage device according to the new ranking and constructs updated visualization information. The server transmits the updated visualization information and the explanatory text to the terminal.

The terminal replaces or augments the previous display with the updated charts and explanations. The user thus receives a context-aware response that is grounded in the previously computed evaluation information, without requiring the server to recompute all feature sets or rerun separate scoring procedures outside of the generative AI model. This reuse of intermediate evaluation information and integrated handling of user prompt sentences contribute to reduced processing time and reduced network traffic between components.

The server improves computer functionality in several ways. By unifying structured performance data and image-derived features, the server creates compact feature sets that reduce the number of separate database queries and repeated computations. The preprocessing pipeline, which includes missing-value completion, normalization, aggregation, and encoding, produces inputs that are optimized for numerical stability and model convergence, thereby lowering the number of iterations required for training and, at inference time, enabling the model to operate with fewer numerical errors. The integration of visual embeddings with numerical features allows the generative AI model to capture correlations that would be difficult to encode using hand-crafted rules, which improves prediction accuracy.

The use of explicit prompt sentences as internal control signals for the generative AI model enables the server to adapt the same model architecture to multiple computational roles without duplicating models or writing separate rule engines. The server can, by changing the prompt sentences, switch the generative AI model between roles such as base evaluation, scenario-specific reweighting, or explanation generation. Because the server encodes prompts and data into a unified token sequence, the model can reuse internal attention mechanisms to capture relationships among instructions, contextual constraints, and numerical features. This architecture reduces the need for hard-coded branching logic and separate query processing modules, thereby reducing memory footprint and simplifying code paths.

In one embodiment, the generative AI model is trained using supervised learning on historical participant data and target evaluation scores determined by domain experts or downstream outcomes. The server constructs training examples in which an input sequence includes a prompt sentence describing the evaluation task and feature values for one or more participants, and the target sequence includes desired evaluation scores and explanatory text.

The server computes a loss function that may include a regression loss for numerical outputs, such as mean squared error, and a language modeling loss, such as cross-entropy loss, for textual outputs. The server updates model parameters using a gradient-based optimization algorithm such as stochastic gradient descent or adaptive gradient methods. The server may employ data augmentation, such as adding noise to numerical features or paraphrasing prompt sentences, to improve model robustness.

The server's training and inference procedures are implemented as concrete computational graphs that are executed on specialized hardware such as graphics processing units. During training, the server manages mini-batch construction, gradient accumulation, and parameter synchronization. During inference, the server limits sequence lengths and uses caching mechanisms to reuse key and value tensors in multi-head attention layers between successive prompt sentences. These implementations decrease latency when processing user queries and reduce power consumption, thereby constituting a technical improvement over naive implementations.

The system is not confined to a single type of competitive activity or data source. In a variant embodiment, the server applies the same architecture to competitive activities such as different sports, games, or other performance-based domains. In another variant embodiment, the feature extraction network for image information is replaced by a different network architecture, such as a vision transformer, while preserving the unified multimodal fusion approach. In yet another variant embodiment, the generative AI model receives additional sensor data, such as positional sensor measurements, as part of the structured feature sets. The prompt sentence design, feature fusion, and evaluation generation procedures are adapted accordingly but follow the same overall pattern.

The server thus uses non-conventional and non-generic data processing steps, such as prompt-controlled multimodal fusion and reuse of evaluation information inside a single generative AI model, to achieve improved technical performance. Latency is reduced because the model can perform re-ranking and explanation without re-executing the full preprocessing pipeline. Accuracy is improved because the model jointly attends to features and instructions, learning complex relationships beyond rule-based methods. Data management is improved because intermediate feature sets and evaluation information are stored and reused in a structured fashion, reducing redundant reads and writes in the storage device. The terminal and user interact with these improved capabilities via prompt sentences and visualizations, but the core improvements reside in the server's internal technical structure and processing flow.

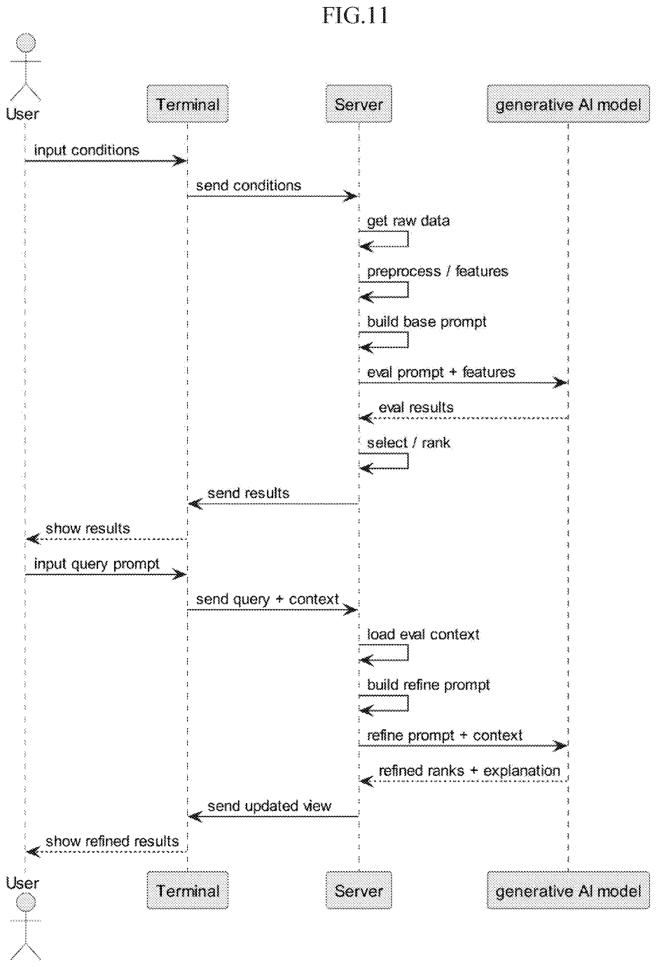

The following describes the processing flow using FIG. 11.

### Step 1:

The terminal receives condition input from the user.
The user operates the terminal to input initial conditions for evaluation, such as type of competitive activity, role, age range, or time period. The terminal displays a user interface including selection fields and text boxes, and the user selects or types values.
Input: user actions (touch events, clicks, keyboard input) representing evaluation conditions.
The terminal converts the user actions into a structured condition object, for example including fields for role, age range, league, and season, and stores this object in memory.
Output: a structured set of evaluation conditions held by the terminal.

### Step 2:

The terminal transmits evaluation conditions to the server.
The terminal constructs a request message containing the evaluation conditions and user identification information. The terminal uses a network interface to send the request to the server over a communication network.
Input: structured evaluation conditions and user identification maintained in terminal memory.
The terminal serializes the evaluation conditions into a message format, attaches authentication data, and issues a network transmission operation.
Output: a network request received by the server that includes the evaluation conditions.

### Step 3:

The server acquires participant information from external information sources.
The server receives the request and parses the evaluation conditions. The server issues database queries and external API calls to obtain participant performance records and image information.
Input: evaluation conditions extracted from the terminal request.
The server converts the conditions into query parameters, executes SQL statements against relational databases, and sends HTTP requests to remote APIs. The server receives tabular data representing statistics and files or URLs representing image information, and stores them in a storage device according to a predefined schema.
Output: raw participant information stored in server-side data repositories.

### Step 4:

The server loads and filters raw participant information.
The server accesses the storage device and loads participant information into main memory using a data analysis library. The server applies filters corresponding to the evaluation conditions, such as role, age range, and time period.
Input: raw participant information stored in the storage device and the evaluation conditions parsed from the request.
The server reads records into data structures (for example, tables or arrays), executes filtering operations to remove records that do not satisfy the conditions, and compiles a subset of records for relevant participants.
Output: a filtered set of participant records in server memory.

### Step 5:

The server performs missing-value completion and normalization.
The server scans the filtered records for null or undefined values and completes missing values using statistical or model-based estimates. The server then normalizes numerical columns to a standard scale.
Input: filtered participant records containing raw numerical values and possible missing entries.
The server computes statistics such as means and standard deviations for each metric, replaces missing values with computed estimates, and applies mathematical transformations (for example, z-score or min-max scaling) to each numerical field to produce normalized values.
Output: a cleaned and normalized set of participant records represented as numerical arrays.

### Step 6:

The server aggregates records into structured feature sets.
The server groups records by participant and time period and computes aggregate metrics, forming numerical feature sequences and time-series feature sequences.
Input: cleaned and normalized participant records in tabular form.
The server executes group-by operations over participant identifiers and time indices, calculates aggregated statistics such as averages per defined time window, counts, and trends, and organizes these statistics into fixed-length vectors or matrices per participant.
Output: structured feature sets including numerical feature sequences and time-series feature sequences for each participant.

### Step 7:

The server generates feature sets corresponding to image information.
The server processes image information associated with the filtered participants to produce numerical feature vectors. The server decodes image or video files into pixel data and applies a feature extraction network.
Input: references to image information (such as file paths or URLs) and participant identifiers.
The server reads image data into memory, converts the image data into tensors representing pixel intensities and color channels, and applies a convolutional or similar neural network to compute intermediate activation vectors. The server aggregates the activation vectors for each participant into fixed-dimensional feature vectors.
Output: feature sets corresponding to image information, indexed by participant.

### Step 8:

The server fuses structured feature sets and image-based feature sets.
The server combines numerical feature sequences and image-derived feature vectors into multimodal feature representations.
Input: structured feature sets from Step 6 and image-based feature sets from Step 7.
The server aligns feature sets by participant identifier, concatenates or otherwise merges numerical and visual features into unified vectors or sequences, and stores the resulting multimodal feature sets in memory or a feature store.
Output: multimodal feature representations for each participant.

### Step 9:

The server constructs a base evaluation prompt sentence.
The server generates a prompt sentence that instructs a generative AI model to perform performance-evaluation computation and preference-degree computation using the multimodal feature sets.
Input: multimodal feature representations and configuration parameters defining evaluation targets (for example, current performance, future growth, role suitability).
The server assembles an instruction text, such as:
“You are a model that evaluates participants in a competitive activity. For each participant, use the provided feature vectors and time-series information to compute a current performance score, a future growth score, and a role suitability score on a scale from 0 to 100, and then compute an overall composite score and rank the participants.”
The server formats this instruction text together with serialized representations of feature values.
Output: a base evaluation prompt sentence combined with encoded feature descriptions.

### Step 10:

The server executes inference of the generative AI model for base evaluation.
The server tokenizes the prompt sentence and feature descriptions and feeds them into the generative AI model to obtain evaluation information.
Input: tokenized prompt sentence and tokenized feature sequences generated by the server.
The server maps tokens to embedding vectors, runs them through multiple layers of the generative AI model, and computes output token sequences. The server then parses output tokens into numerical values for indices such as current-performance index, future-growth index, role-suitability index, and a composite evaluation index, and optionally textual comments.
Output: evaluation information including multiple numerical indices and descriptive text for each participant.

### Step 11:

The server selects and ranks a candidate group of participants.
The server analyzes the evaluation information and determines a subset of participants to constitute a candidate group, ranked by composite evaluation index or other criteria.
Input: evaluation information from Step 10 and any additional selection constraints derived from the evaluation conditions.
The server sorts participants by composite evaluation index or another calculated metric, filters participants based on constraints such as age or role, selects the top participants according to a predetermined rule, and assigns rank positions to the selected participants.
Output: a candidate group of participants with associated ranks and evaluation indices.

### Step 12:

The server generates visualization information for the terminal.
The server translates evaluation information and candidate rankings into chart data, tables, and textual summaries suitable for display.
Input: evaluation information and the ranked candidate group.
The server computes chart parameters, such as axis values for radar charts, bar heights for ranking charts, and line series for time-series plots, and creates a structured visualization specification that associates each participant with graphical elements and labels. The server also includes textual summaries derived from the evaluation information.
Output: visualization information including chart specifications, tabular data, and textual descriptions.

### Step 13:

The server transmits visualization information to the terminal.
The server packages the visualization information into a response message and sends it to the terminal through the network interface.
Input: visualization information from Step 12 and terminal identification extracted from the request.
The server serializes the visualization information into a message format, attaches any necessary metadata, and executes a network send operation to the terminal.
Output: a response message received by the terminal containing visualization information.

### Step 14:

The terminal renders evaluation results.
The terminal receives the response message, parses the visualization information, and displays charts, tables, and text on the display device.
Input: visualization information contained in the server response.
The terminal maps chart specifications to drawing commands, renders graphical elements onto the display using a chart library or native graphics API, and populates tables and text areas with evaluation values and summaries so that the user can inspect the candidate group and associated scores.
Output: a graphical and textual presentation of evaluation results visible to the user.

### Step 15:

The user reviews the displayed information and identifies questions or refinement needs.
The user observes rankings, indices, and visual patterns on the terminal and may decide to request explanations or re-ranking.
Input: evaluation results presented on the terminal display.
The user interprets the information and mentally formulates additional criteria or questions, such as focusing on long-term potential or a specific style.
Output: a user intention to input a new query.

### Step 16:

The terminal captures a query prompt sentence from the user.
The terminal presents a text input field and the user enters a prompt sentence expressing a query or refinement condition.
Input: user keystrokes or voice input converted to text, for example:
“Explain why the top three participants are recommended, focusing on consistency over time and suitability for a high-intensity role.”
The terminal aggregates the input characters into a string and validates it as a prompt sentence.
Output: a query prompt sentence stored in terminal memory.

### Step 17:

The terminal transmits the query prompt sentence and context to the server.
The terminal constructs a query message containing the prompt sentence, identifiers of the current candidate group, and any relevant evaluation context.
Input: the query prompt sentence from Step 16 and the current evaluation and candidate identifiers displayed on the terminal.
The terminal packages these elements into a request payload and sends it over the network to a designated server endpoint.
Output: a query request received by the server that includes the user's prompt sentence and contextual identifiers.

### Step 18:

The server retrieves evaluation information and candidate context.
The server parses the query request to identify the candidate group and associated evaluation information, then accesses the storage device to load these records into memory.
Input: candidate identifiers and prompt sentence extracted from the terminal request.
The server executes lookup operations in evaluation tables or feature stores, obtains indices and previous summary text for the identified participants, and constructs a context object that groups this information by participant.
Output: an in-memory representation of evaluation information and candidate context associated with the user's query.

### Step 19:

The server constructs an integrated input and a refinement prompt sentence.
The server generates a refinement prompt sentence that instructs the generative AI model to adjust rankings or provide explanations according to the user's query and the existing evaluation information.
Input: the user's query prompt sentence and the evaluation context object from Step 18.
The server composes instruction text such as:
“You are a model that refines candidate rankings and generates explanations. Using the existing evaluation scores and the user's request, adjust the weights of the current performance and future growth indices, recompute composite scores, update the ranking, and provide a detailed explanation.”
The server appends the user's prompt sentence and structured descriptions of evaluation indices for each candidate after the instruction. The server concatenates these elements into a single integrated text input.
Output: an integrated input string containing a refinement prompt sentence, the user's query, and evaluation context.

### Step 20:

The server executes inference of the generative AI model for refinement and explanation.
The server tokenizes the integrated input and provides the tokens to the generative AI model to compute response information.
Input: tokenized integrated input produced from the text in Step 19.
The server performs embedding, attention, and decoding operations according to the model architecture, and obtains output tokens representing updated indices, ranking changes, and explanatory text. The server parses numerical information from the output and isolates explanatory sentences.
Output: response information including updated composite indices, modified ranking orders, and textual explanations tied to the candidate group.

### Step 21:

The server updates candidate group and visualization information based on the response information.
The server modifies the stored candidate group and evaluation information to reflect the new ranking and any recalculated scores, then generates new visualization information for the terminal.
Input: response information from Step 20 and existing candidate group and visualization specifications.
The server applies new rank positions and indices to candidate records, recomputes chart parameters to reflect updated scores, and constructs revised visualization specifications and explanation text blocks.
Output: updated candidate group data and updated visualization information.

### Step 22:

The server transmits updated visualization and explanations to the terminal.
The server packages the updated visualization information and explanatory text into a response message and sends it to the terminal.
Input: updated visualization specifications and generated explanations from Step 21.
The server serializes these elements, appends necessary metadata, and issues a network response to the terminal's query.
Output: an updated visualization message received by the terminal.

### Step 23:

The terminal presents refined results and explanations to the user.
The terminal parses the updated message, refreshes the display to show the revised ranking and indices, and displays the explanatory text so that the user can understand the rationale for changes.
Input: updated visualization information and explanatory text from the server.
The terminal redraws charts and tables using new parameters, replaces or overlays previous graphics, and presents the explanation in a readable format, such as a text panel or dialogue.
Output: a refined and explained presentation of evaluation results visible to the user.

### Step 24:

The user performs final selection or repeated refinement.
The user reviews the refined rankings and explanations and either selects final participants or chooses to input additional prompt sentences for further refinement.
Input: refined evaluation results and explanations shown on the terminal.
The user may select specific participants using selection controls on the terminal, or may generate additional queries that again follow Steps 16 through 23.
Output: final selection decisions or additional user prompt sentences that drive subsequent iterations of the described processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale environments where multiple physical targets, such as industrial devices or automated machines, must be evaluated and assigned to tasks, conventional computer systems rely on fragmented analytics pipelines. Typically, a first subsystem collects sensor signals and images, a second subsystem performs model inference to estimate performance metrics, and a separate user interface or rule engine assists a human operator in making final assignment decisions. In such architectures, each subsystem operates on its own data representation and decision logic, and integration is performed manually or through ad hoc scripts. As a result, latency increases, data consistency degrades, and the ability of the overall system to adaptively improve recommendations in response to user feedback is limited.

Furthermore, conventional use of machine learning models in such systems is often restricted to point estimation of scores or classifications. While these models can compute performance indices or suitability indices, they do not effectively explain their recommendations, do not flexibly refine arrangement plans under additional constraints, and do not provide natural-language justification that is easily consumable by human operators. Decisions such as arrangement of multiple targets to multiple tasks are therefore often finalized through manual trial-and-error, which is time-consuming and prone to suboptimal outcomes.

Additional difficulties arise when attempting to incorporate advanced generative AI models into this decision-making loop. In existing systems, generative AI models may be used superficially to generate descriptive text, but there is no tightly integrated mechanism to (i) transform raw time-series and image data into structured decision-ready representations, (ii) construct prompt sentences that explicitly instruct the generative AI model to perform capability evaluation and plan validation, and (iii) iteratively re-optimize arrangement candidates using both AI outputs and user-specified constraints. Without such integration, generative AI models cannot reliably contribute to concrete optimization of arrangements, and the computational resources expended on generative inference do not yield systematic improvements in system performance.

A further technical problem resides in the inefficient use of processor resources and memory in multi-stage evaluation and arrangement systems. When evaluation data, clustering results, candidate arrangement plans, and user preferences are not represented in a unified structured format, the processor must perform repeated conversions between heterogeneous data structures, incurring overhead and increasing response time. This prevents the system from supporting near real-time reconfiguration of arrangements based on updated sensor streams and user feedback.

Therefore, there is a need for an improved computer-implemented system that (1) automatically consolidates operation data and image information of multiple targets into time-aligned structured data, (2) uses a machine learning model to compute performance, safety, and suitability indices, (3) generates and evaluates candidate arrangement plans using clustering and ranking, and (4) tightly integrates a generative AI model, via explicitly constructed prompt sentences, to produce explanation information, improvement proposals, and iterative re-optimization under user constraints. Such a system should reduce the computational and cognitive burden on operators, improve the quality and transparency of arrangement decisions, and enhance the efficiency and scalability of the underlying computer technology for multi-target arrangement and decision support.

The specific processing by the specific processing unit 290 of the data processing device 12 in Application Example 1 is realized by the following means.

The present invention provides a server comprising a processor configured to acquire operation data and image information of a plurality of targets from one or more data sources, to associate the operation data and the image information with each other along a time series, and to store the associated data in a storage as structured records; to divide the image information into image units, to extract feature values from the image units and from the operation data, to generate preprocessed data, and to evaluate performance and suitability of each target by inputting the preprocessed data into a machine learning model that outputs evaluation results including performance indices, safety indices, and suitability indices; to perform a clustering calculation on the evaluation results to group the plurality of targets, and for each group to perform ranking based on suitability for predetermined tasks so as to generate candidate arrangement plans representing assignments of the targets to the predetermined tasks; to generate input information including structured data comprising the candidate arrangement plans and the evaluation results, and including a prompt sentence that instructs analysis content of the structured data and presentation content of an optimal arrangement plan, to input the input information into a generative AI model, and to acquire response information including explanation information and improvement proposals regarding the candidate arrangement plans; and to present arrangement candidates and recommended arrangements of the targets to a user based on the response information and the candidate arrangement plans, to receive selection of a final arrangement or constraint information and preference information from the user, and to output arrangement information representing the final arrangement and, when the constraint information and the preference information are received, to re-evaluate and update the candidate arrangement plans using additional prompt sentences and additional analysis by the generative AI model. This enables an integrated computer-implemented pipeline in which raw multi-modal data are transformed into unified structured representations, machine learning and clustering are used to derive quantitative evaluation and grouping, and a generative AI model-controlled by explicitly constructed prompt sentences-is employed to generate explanations and iterative refinements of arrangement plans, thereby improving computational efficiency, decision quality, and adaptability of the system in assigning multiple targets to tasks under changing operational and user-defined constraints.

The term “processor” refers to one or more hardware-based processing circuits, such as a central processing unit, a graphics processing unit, a digital signal processor, or any combination thereof, configured to execute instructions and perform data processing operations.

The term “target” refers to a physical or virtual entity to be evaluated and arranged, including but not limited to an industrial apparatus, an automated machine, a robot, or another controllable device operating in an environment.

The term “operation data” refers to data representing behavior or state of a target over time, including but not limited to sensor readings, control signals, status flags, error logs, and performance measurements.

The term “image information” refers to visual data representing a target or its surroundings, including still images, video frames, or sequences of such images acquired by an imaging device.

The term “time series” refers to an ordered sequence of data elements, each associated with a time value, such that operation data and image information can be temporally aligned based on corresponding timestamps.

The term “storage” refers to any hardware-based memory or data repository, including volatile memory, non-volatile memory, magnetic storage, optical storage, or a combination thereof, configured to store data and programs.

The term “image unit” refers to a discrete element of image information, such as a single frame of a video or a single still image, used as a unit of processing for analysis.

The term “feature value” refers to a numerical or categorical indicator derived from raw operation data or image information, representing a characteristic such as intensity, velocity, frequency component, or other measurable attribute used for machine learning.

The term “preprocessed data” refers to data obtained by transforming, normalizing, or otherwise processing raw operation data and image information, including extracted feature values, into a format suitable for input to a machine learning model.

The term “machine learning model” refers to a computational model generated by a training process on example data, including but not limited to a neural network, a decision tree model, a regression model, or an ensemble model, configured to output evaluation results based on input data.

The term “evaluation result” refers to an output from a machine learning model that quantitatively or qualitatively assesses characteristics of a target, including performance indices, safety indices, and suitability indices.

The term “performance index” refers to a numerical measure that indicates effectiveness or efficiency of a target in performing one or more tasks, such as throughput, accuracy, or cycle time.

The term “safety index” refers to a numerical measure that indicates a degree of safety or risk associated with operation of a target, such as probability of failure, error frequency, or violation of safety thresholds.

The term “suitability index” refers to a numerical measure that indicates how appropriate a target is for a predetermined task or operating condition, based on characteristics such as precision, speed, or load capacity.

The term “clustering calculation” refers to a data processing operation that groups multiple targets into subsets based on similarity of evaluation results or feature values, using an unsupervised learning algorithm or another grouping algorithm.

The term “candidate arrangement plan” refers to data representing a proposed assignment of multiple targets to multiple tasks, stations, or positions, including mapping information indicating which target is allocated to which task.

The term “structured data” refers to data organized according to a predefined schema, such as a table, record, or hierarchical format, enabling systematic access to elements such as evaluation results, cluster labels, and arrangement plans.

The term “prompt sentence” refers to a textual instruction or query provided to a generative AI model, specifying analysis content, output format, constraints, or objectives for generation of response information.

The term “generative AI model” refers to a machine learning model configured to generate text or other data based on input information and learned patterns, including but not limited to a large language model or another generative model trained on example data.

The term “input information” refers to an aggregation of data provided to a generative AI model, including structured data and one or more prompt sentences, used to control content and scope of generation.

The term “response information” refers to data generated by a generative AI model in response to input information, including at least explanation information, recommendations, and improvement proposals related to arrangement plans.

The term “explanation information” refers to textual or symbolic content that describes reasons, factors, or rationale underlying a recommended arrangement or evaluation, in a form understandable by a user.

The term “improvement proposal” refers to information indicating modifications to candidate arrangement plans or configurations, aimed at enhancing one or more objectives such as performance, safety, or resource utilization.

The term “arrangement candidate” refers to an element within a candidate arrangement plan that specifies a possible assignment of a particular target to a particular task, station, or position.

The term “recommended arrangement” refers to an arrangement candidate or arrangement plan identified as preferable based on evaluation results, clustering, ranking, and analysis by a generative AI model.

The term “arrangement information” refers to data that specifies a finalized or selected arrangement of targets, including identifiers of targets, tasks, and positions, and optionally associated parameters or constraints.

The term “constraint information” refers to data representing limitations or conditions specified by a user or system, such as capacity limits, exclusion rules, mandatory assignments, or operational restrictions.

The term “preference information” refers to data representing user-specified priorities, preferences, or weightings, such as favoring certain targets, favoring particular performance indices, or prioritizing safety over throughput.

The term “re-evaluation” refers to processing that assesses and potentially modifies candidate arrangement plans based on updated information, including generative AI outputs, constraint information, or preference information.

The term “additional analysis” refers to further processing by a generative AI model invoked after initial analysis, typically using updated prompt sentences and structured data to refine or adjust arrangement recommendations.

In one embodiment, a server, one or more terminals, and one or more users cooperate to implement the claimed system. The server includes at least one processor, a main memory, a non-volatile storage device, and a network interface. The processor may be a central processing unit, a graphics processing unit, or a combination thereof. The storage device stores executable programs and data structures that, when executed or accessed by the processor, cause the server to perform the functions described below. The terminal includes an imaging device, a communication interface, a display, and an input device such as a touch panel.

The server acquires operation data and image information of multiple targets from field devices and terminals. The server uses a network interface to receive time-series sensor signals from measurement devices such as torque sensors, position encoders, and current sensors, and to receive image information such as video streams or still images from cameras. In one example, the server receives a video stream encoded in a standard compression format over a real-time streaming protocol and decodes the stream into individual frames by using image processing software such as a computer vision library. The server converts each frame into a multi-dimensional array of pixel values and stores the array in memory.

The server associates the operation data and image information with one another along a time series. The server assigns timestamps to sensor values and to video frames based on synchronized clocks or embedded time codes. The server stores the associated data in a structured form, for example as records in a time-series table in a relational database management system. Each record may include a target identifier, a timestamp, one or more sensor values, and a reference to a corresponding image frame. By storing operation data and image information in a unified, time-aligned structure, the server reduces the amount of redundant conversion operations and improves data locality in memory, which leads to faster access during subsequent processing.

The server divides the image information into image units and extracts feature values from the image units and from the operation data. The server treats each image frame as an image unit. The server performs image preprocessing operations, such as resizing, cropping, and normalization of pixel values, by using numerical computation libraries. The server also applies spatial filtering, edge detection, or region-of-interest extraction to emphasize relevant parts of a target, such as a moving arm of a machine, and to reduce irrelevant background. From the preprocessed image, the server extracts feature values such as joint positions estimated from keypoint detection, motion vectors between consecutive frames, and intensity distributions.

The server extracts feature values from the operation data as well. For example, the server computes statistical features over a sliding time window, including mean, variance, and maximum values of torque, velocity, and vibration signals. The server further derives frequency-domain features by applying a discrete Fourier transform or other spectral analysis to the sensor signals. The server normalizes each feature dimension by subtracting a mean value and dividing by a standard deviation determined from a training dataset. By applying the same normalization parameters consistently, the server ensures that the numeric ranges of different features are suitable for joint processing in a machine learning model.

The server generates preprocessed data by combining the image-based features and sensor-based features into a unified data structure. In one embodiment, the server creates, for each target and each time window, a feature vector that includes elements for the extracted image features and operation features, and a corresponding image tensor representing the preprocessed image unit. The server stores these feature vectors and tensors in memory as contiguous arrays. This organization reduces cache misses and improves throughput when the processor accesses the data for batch inference, thereby increasing overall processing speed.

The server evaluates performance and suitability of each target by inputting the preprocessed data into a machine learning model. In one embodiment, the server executes a deep neural network that includes a convolutional neural network for processing image tensors and a fully connected network for processing feature vectors. The convolutional neural network may include multiple convolutional layers, pooling layers, and non-linear activation functions. The fully connected network may include several dense layers that receive concatenated outputs of the convolutional network and the feature vector. The server configures the network to output evaluation results such as a performance index, a safety index, and a suitability index for each predetermined task type.

The server trains the machine learning model in advance by using stored historical data. During training, the server divides labeled data into mini-batches, propagates input through the network, computes a loss value such as a weighted sum of a mean squared error loss and a cross-entropy loss, and updates network weights according to a gradient-based optimization algorithm. The server may apply regularization techniques such as weight decay and dropout, and may use data augmentation operations on images, such as random cropping and horizontal flipping, to improve generalization. By training the network with both image-based and sensor-based features, the server enables the model to capture temporal-spatial patterns that human operators cannot reliably detect or quantify. As a result, the server improves prediction accuracy for complex performance and safety characteristics and reduces variance in evaluation results compared to manual inspection.

The server performs a clustering calculation on the evaluation results to group multiple targets. The server constructs, for each target, an evaluation vector including aggregated values of the performance index, safety index, and suitability indices over a predetermined period. The server applies an unsupervised learning algorithm, such as a partition-based clustering method or a density-based clustering method, to the evaluation vectors. The server determines cluster centers or density maxima, and assigns each target to one of a plurality of groups based on similarity measures such as Euclidean distance. The server stores a cluster label for each target in the database. Because clustering is based on numerical evaluation results computed from high-dimensional features, the server groups targets according to complex performance patterns that cannot be represented by simple threshold rules.

The server generates candidate arrangement plans based on clustering and ranking. The server sets ranking criteria for each predetermined task type by assigning weights to indices. For example, for a precision task, the server may assign a higher weight to a stability-related index and a lower weight to a throughput-related index, whereas for a high-speed task, the server may assign a higher weight to a throughput-related index. The server computes, for each target and task type, a composite score by calculating a weighted sum of the relevant indices. The server sorts targets in descending order of composite score for each task type and constructs a list of top-ranked targets. The server then creates candidate arrangement plans by mapping tasks or stations to suitable targets according to the ranking lists while satisfying basic constraints such as avoidance of duplicate assignment. By executing these steps algorithmically, the server eliminates ad hoc manual trial-and-error in constructing arrangement plans, and reduces computation time compared to exhaustive search.

The server generates input information for a generative AI model by combining structured data and a prompt sentence. The structured data includes the evaluation results per target, the cluster labels, and the candidate arrangement plans. The server encodes this information in a machine-readable form such as a table structure or hierarchical representation. The server prepares a prompt sentence in natural language that explicitly instructs the generative AI model regarding analysis content and output requirements. In one example, the server generates a prompt sentence such as:
“You are an expert in equipment allocation. Analyze the following performance scores, safety indices, suitability indices, and candidate arrangement plans for multiple targets. Select the most appropriate arrangement plan, explain the reasons for your selection in detail, and propose any modifications that could further improve throughput while maintaining safety.”

In another example, the server uses a prompt sentence such as:
“The following data describe multiple machines, including performance indices, safety indices, and clustering results. Based on this information, recommend which machines should be assigned to precision tasks, high-speed tasks, and heavy-load tasks, and explain the trade-offs between different arrangement options.”

The server then sends the prompt sentence and the structured data to a generative AI model. The generative AI model may be implemented as a large language model running on a computing platform. The server accesses the generative AI model via an application programming interface over a network. The server specifies generation parameters, such as maximum output length and sampling temperature, to control determinism and completeness of the response.

The server acquires response information from the generative AI model and processes the response. The response information includes explanation information describing the reasoning behind recommended arrangements, and improvement proposals suggesting modifications to candidate arrangement plans. The server parses the response to identify references to specific targets, tasks, and arrangement plans, and associates the explanation information and improvement proposals with corresponding identifiers in the database. Because the server controls the form and content of prompt sentences, and because the server injects precise structured data into the generative AI model, the server shapes the generative output into structured, technically relevant recommendations instead of general text. This design improves reproducibility and reduces ambiguity in AI-generated recommendations.

The server presents arrangement candidates and recommended arrangements to the user through the terminal. The server transmits, to the terminal, information including the candidate arrangement plans, the recommended arrangement identified in the response, and the explanation information. The terminal displays this information on a screen in a structured layout. The user operates the terminal by using touch input or other input means to review different arrangement plans, explanation details, and quantitative indices. The user may input constraint information and preference information, such as prohibiting use of a particular target for a specific task, assigning higher importance to safety than to throughput, or specifying a maximum number of targets allowed in a region. The terminal transmits the user's constraint information and preference information to the server.

The server re-evaluates the candidate arrangement plans based on the response information and the user-provided constraint information and preference information. The server filters or adjusts the ranking of targets in accordance with the constraints and preferences, and may generate additional candidate arrangement plans that satisfy the new conditions. The server also constructs a new prompt sentence that describes the updated constraints and preferences and instructs the generative AI model to perform additional analysis. For example, the server may generate a prompt sentence such as:
“Re-evaluate the arrangement plans considering the following new constraints: target T3 must not be used for high-speed tasks, and safety indices must be prioritized over throughput indices. Recommend an updated arrangement plan and explain how the new plan satisfies the constraints while maintaining overall performance.”

The server sends the updated structured data and prompt sentence to the generative AI model and receives refined recommendations. By iteratively refining prompt sentences and structured data according to user feedback, the server implements an adaptive optimization loop that surpasses simple static rule-based systems and manual graph inspection.

The server outputs arrangement information representing the final arrangement after the user confirms a recommended plan via the terminal. The arrangement information includes mapping of targets to tasks or stations and optionally includes parameter settings such as speed limits or safety margins for each target. The server may generate configuration records or files suitable for consumption by external control systems, such as a manufacturing execution platform or a device controller. By generating these outputs in a structured format derived from machine-readable arrangement information, the server enables direct application of the arrangement to physical equipment without requiring manual transcription.

This system improves computer technology in multiple ways. Because the server stores time-aligned multi-modal data in a unified structure and processes batch feature vectors and image tensors together, the server reduces input/output overhead and improves cache efficiency on the processor, thereby reducing inference latency. Because the server uses a multi-branch neural network architecture that jointly processes image features and sensor features, the server achieves higher accuracy in evaluation of performance and safety indices than approaches relying on a single modality, which in turn reduces misassignments. Because the server performs clustering and ranking using numeric evaluation results, the server avoids combinatorial explosion in arrangement planning and can generate high-quality candidate plans with reduced computational cost compared to exhaustive search. Because the server uses explicitly constructed prompt sentences combined with structured data to control a generative AI model, the server obtains consistent, technically meaningful explanations and improvement proposals that are directly mapped back to system data structures, which improves traceability and reduces cognitive burden on the human operator.

Furthermore, the system does not merely automate a human mental process. The server performs non-conventional steps such as joint representation learning of image and sensor features, time-series synchronization at sub-second resolution, and iterative prompt-controlled generation and re-evaluation tightly integrated with structured data storage. These steps involve specific data structures, algorithms, and control flows implemented in the processor and are not practical to perform manually with comparable speed and accuracy. The result is a technical effect of improved throughput in data processing, reduced error in arrangement decisions, and reduced network communication overhead due to the use of concise structured representations between server and terminal.

In alternative embodiments, the server may use different types of machine learning models, such as gradient boosting models for numerical features combined with a convolutional network for images, or may employ different clustering algorithms adapted to the number of targets and variability in evaluation results. The prompt sentences may be varied according to domain context, for example to focus on minimizing energy consumption instead of maximizing throughput. The terminals may be mobile devices, fixed operator consoles, or web clients, and the network communication may use different protocols as long as the data structures and control flows remain consistent with those described above. Through these variations, the system maintains the core technical contribution of an integrated, prompt-driven, AI-assisted arrangement engine that optimizes assignment of multiple targets based on time-aligned multi-modal data and structured machine learning outputs.

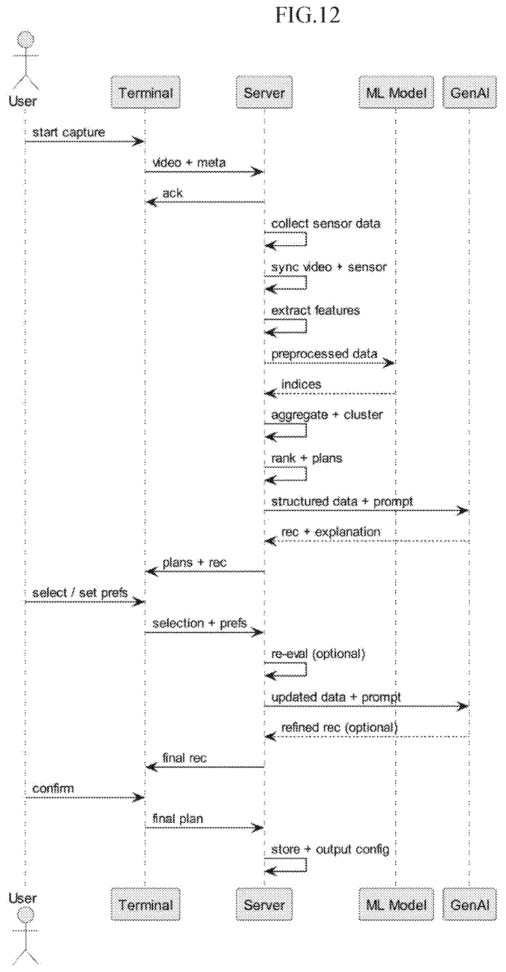

The following describes the processing flow using FIG. 12.

### Step 1:

The terminal captures image information and operation context of targets.
The terminal uses an imaging device to record video or still images of each target during operation and associates basic metadata such as time, target identifier, and location.
The input to the terminal is a user instruction to start recording and a list of targets or areas to be observed.
The terminal encodes the captured video into a compressed format, segments it into files or streams, attaches metadata (including timestamps synchronized to a reference clock), and outputs an encoded image stream and associated metadata records.
The terminal transmits the encoded image stream and metadata to the server via a communication interface.

### Step 2:

The server collects operation data from sensors and receives image information from the terminal.
The input to the server is (i) the encoded image stream and metadata from the terminal, and (ii) time-series sensor values from measurement devices connected over an industrial network.
The server decodes the image stream into individual frames, assigns or verifies timestamps for each frame, and buffers these frames in memory.
The server simultaneously subscribes to sensor channels, reads values such as torque, position, current, and vibration, and stores them in a time-series buffer with timestamps and target identifiers.
The server outputs synchronized raw image frames and raw operation data stored in a storage subsystem.

### Step 3:

The server associates image frames and operation data along a time series.
The input to the server is the set of raw image frames with timestamps and the time-series operation data with timestamps.
The server aligns timestamps by using a clock synchronization reference, and for each frame locates operation data records within a specified time window around the frame time.
The server creates combined records that include a frame identifier, a target identifier, and a list of corresponding sensor values, discarding unmatched frames or sensor records outside the tolerance window.
The server outputs a time-aligned dataset in which each record links one image frame and a corresponding segment of operation data.

### Step 4:

The server preprocesses image frames into image tensors and extracts image-based features.
The input to the server is the time-aligned dataset including raw image frames.
The server resizes each frame to a standard resolution, normalizes pixel values, optionally crops a region of interest around the target, and converts each frame into a multi-dimensional array suitable for numerical computation.
The server then applies image processing operations or a front-end convolutional layer to derive image-based features such as motion indicators, structural contours, and estimated positions of key parts.
The server outputs, for each time-aligned record, a normalized image tensor and an image feature vector.

### Step 5:

The server preprocesses operation data and extracts operation-based features.
The input to the server is the time-aligned dataset including segments of operation data for each frame.
The server applies filtering to remove noise from sensor signals, aggregates values over a sliding window (for example, computing mean, variance, and extrema of torque, velocity, and vibration), and calculates frequency-domain descriptors by applying a spectral transform.
The server normalizes each operation feature dimension based on previously stored mean and variance parameters so that all features fall into a range suitable for machine learning.
The server outputs, for each time-aligned record, a normalized operation feature vector.

### Step 6:

The server constructs unified preprocessed data for machine learning.
The input to the server is the set of image feature vectors, image tensors, and operation feature vectors for each time-aligned record.
The server concatenates the image feature vector and the operation feature vector into a single numerical feature vector and associates this vector with the corresponding image tensor and target identifier.
The server groups multiple records into batches to improve computational efficiency and organizes them in contiguous memory so that the processor and, if present, the graphics processor can access them with reduced cache misses.
The server outputs batched preprocessed data comprising, for each batch, a set of image tensors, a set of feature vectors, and target identifiers.

### Step 7:

The server evaluates performance and suitability of targets using a machine learning model.
The input to the server is the batched preprocessed data.
The server loads a trained machine learning model, such as a multi-branch neural network that accepts image tensors and feature vectors, and forwards each batch through the model.
The server computes, for each record, output values including a performance index, a safety index, and one or more suitability indices for different task types, and stores these indices with the corresponding target identifier and timestamp.
The server outputs evaluation results for each target and each time interval, forming a high-dimensional evaluation dataset.

### Step 8:

The server aggregates evaluation results into target-level indices over a predetermined period.
The input to the server is the evaluation dataset containing per-record indices.
The server groups records by target identifier and by analysis period, then calculates aggregated values such as mean, median, and extreme values of the performance index, safety index, and suitability indices.
The server may additionally compute derived metrics such as stability scores (based on fluctuations in indices) or risk scores (based on frequency of low-safety events).
The server outputs a compact evaluation profile for each target, including aggregated indices and derived metrics.

### Step 9:

The server clusters targets based on evaluation profiles.
The input to the server is the set of evaluation profiles for all targets.
The server constructs a matrix where each row represents one target and each column represents one aggregated index or derived metric.
The server applies a clustering algorithm to this matrix, calculating distances between rows and assigning cluster labels that group targets with similar performance and safety characteristics.
The server outputs, for each target, a cluster label and stores the cluster structure as part of the system state.

### Step 10:

The server ranks targets for each predetermined task type and generates candidate arrangement plans.
The input to the server is the set of evaluation profiles and cluster labels.
The server defines scoring formulas for each task type by assigning weights to indices; then, for each target and task type, the server multiplies each index by its corresponding weight and sums the results to obtain a composite task-specific score.
The server sorts targets by composite score for each task type, constructs ranked lists, and then combines these lists according to assignment rules to build one or more candidate arrangement plans, each specifying which target is assigned to which task or station.
The server outputs a collection of candidate arrangement plans along with associated scores and references to targets.

### Step 11:

The server prepares structured data and a prompt sentence for a generative AI model.
The input to the server is the collection of candidate arrangement plans, evaluation profiles, and cluster labels.
The server formats this information into a structured representation that includes, for each target, its indices, cluster label, and proposed assignments, and, for each plan, its overall expected performance and risk metrics.
The server generates a prompt sentence in natural language that instructs the generative AI model to analyze the structured data, select or refine arrangement plans, and provide explanations and improvement proposals.
The server outputs combined input information, consisting of the structured data and the prompt sentence, ready to be sent to the generative AI model.

### Step 12:

The server invokes the generative AI model and acquires response information.
The input to the server is the combined input information prepared in the previous step.
The server sends the prompt sentence and structured data to the generative AI model over a network interface, specifying generation parameters such as maximum token count and sampling strategy.
The generative AI model returns a text response, and the server receives this response, parses it to identify explicit recommendations (such as a selected plan or modified assignments) and explanation text associated with each target and plan.
The server outputs structured response information containing recommended arrangements, explanation information, and improvement proposals, all linked to internal identifiers.

### Step 13:

The server transmits recommendations and explanations to the terminal for user presentation.
The input to the server is the structured response information and the original candidate arrangement plans.
The server composes a response message including the recommended arrangement, the alternative plans, key indices, and human-readable explanations, and sends this message to the terminal via a communication interface.
The server may also compress the message or omit redundant details to reduce communication load while retaining essential information needed for decision-making.
The server outputs a compact data package that the terminal can render as a graphical interface.

### Step 14:

The terminal displays arrangement candidates and receives user feedback.
The input to the terminal is the data package containing candidate arrangement plans, the recommended arrangement, and explanation information.
The terminal generates user interface screens showing, for example, a list of targets, their indices, their cluster categories, and the positions or tasks to which they are assigned in each plan, along with textual explanations from the generative AI model.
The user reads the displayed information, uses touch or other inputs to select a plan, specify additional constraints, or express preferences such as favoring lower risk over higher throughput.
The terminal outputs user selection data and any constraint or preference information, which it sends back to the server.

### Step 15:

The server re-evaluates candidate arrangement plans based on user feedback and optionally performs additional generative analysis.
The input to the server is the user selection data, constraint information, and preference information from the terminal, along with the previously generated candidate arrangement plans and response information.
The server adjusts the ranking of targets and filters plans that violate user-specified constraints, then may generate new candidate arrangements by reassigning targets to tasks under the updated conditions.
If further guidance is needed, the server constructs an updated prompt sentence that describes the new constraints and objectives, adds the updated structured data, and sends this information to the generative AI model to obtain refined suggestions and explanations.
The server outputs an updated set of arrangement candidates or a finalized recommended arrangement that satisfies both system-derived criteria and user requirements.

### Step 16:

The user reviews the final recommendations and confirms a final arrangement.
The input to the user is the updated arrangement information and explanation text displayed on the terminal.
The user compares different options, taking into account numerical indices, cluster categories, and narrative explanations, and decides which arrangement to adopt.
The user confirms the decision by selecting a final arrangement on the terminal interface.
The terminal captures this confirmation and outputs a final arrangement selection message to the server.

### Step 17:

The server outputs final arrangement information for implementation.
The input to the server is the final arrangement selection message from the terminal.
The server retrieves the corresponding arrangement plan, formats it into arrangement information that includes target identifiers, assigned tasks or stations, and any relevant configuration parameters, and stores this information in persistent storage.
The server may also generate configuration messages or files for external systems, such as control devices or supervisory systems, and transmit them over appropriate interfaces to enable physical implementation of the selected arrangement.
The server outputs final arrangement information that can be used to reconfigure or control equipment in the real-world environment.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented scouting and selection systems suffer from several technical limitations in how they process, query, and present large-scale performance data.

First, existing systems typically rely on rigid, pre-defined query interfaces that require users to specify fixed filter items and parameter ranges. The underlying data processing pipelines often operate on heterogeneous performance information and media information without robust normalization or cleaning. As a result, the system must perform repeated ad hoc conversions and validations at query time, which increases processor load, leads to inconsistent query results, and degrades response latency as the volume and variety of stored records grow.

Second, traditional evaluation engines generally apply static rule-based formulas or limited machine learning models on a narrow set of attributes. These engines do not systematically generate structured feature vectors from cleaned and normalized data, nor do they effectively couple such feature vectors to a trained evaluation model running on a dedicated machine learning computation resource. This reduces the accuracy and stability of numerical evaluation scores and forces the system to execute additional compensating calculations or manual adjustments, further increasing computational overhead and complexity.

Third, when a user attempts to retrieve candidates that satisfy complex multi-dimensional conditions, existing systems require the user to translate high-level selection intentions into low-level database queries or a combination of UI controls. These systems lack a mechanism to accept natural-language prompt sentences, automatically interpret implicit selection conditions, and transform such conditions into structured query control information that governs search and ranking operations over large-scale data. Consequently, the system either executes inefficient broad queries or performs multiple sequential queries, causing unnecessary data access, redundant computations, and degraded throughput.

Fourth, current systems generally present search results as static lists without dynamically adjusting ranking based on contextual or supplemental information, such as emotion-related adjustment factors, and without generating machine-readable structures that can be used to further refine database queries. This separation between natural-language interfaces and underlying structured search processing prevents the processor from optimizing memory access patterns, cache usage, and query planning based on the user's actual intent, which limits scalability and responsiveness as the number of subjects and attributes increases. Therefore, there is a need for an improved computer-implemented system and server architecture that (i) systematically organizes raw behavior information and viewing information into structured, cleaned, and normalized data, (ii) generates and stores numerical evaluation information using a trained evaluation model on a machine learning computation resource, and (iii) cooperates with a generative AI model to convert natural-language prompt sentences into structured condition information and query control information that can efficiently drive database search and ranking operations. Such a system should improve the technical performance of the processor and memory subsystem in handling large-scale subject data, reduce redundant computations, and provide low-latency, accurate candidate list generation.

The specific processing by the specific processing unit 290 of the data processing device 12 in Example 2 is realized by the following means.

The present invention provides a server comprising a processor and a storage device, the processor being configured to acquire behavior information and viewing information regarding subjects from an operation terminal, store the behavior information and the viewing information as structured information in the storage device, and perform information organization processing including information format checking and missing-value processing on the structured information to generate organized structured information; to extract attribute information and numerical information from the organized structured information, perform normalization processing on the numerical information and encoding processing on the attribute information to generate feature information, input the feature information to a trained evaluation model executed on a machine learning computation resource, calculate numerical evaluation information for each subject, and store the numerical evaluation information in association with each subject in the storage device; to extract a candidate subject group that satisfies selection conditions including a role condition, an age condition, and a performance condition based on the numerical evaluation information and the attribute information, and generate candidate subject list information in which the candidate subject group is ranked according to the numerical evaluation information; to receive, from the operation terminal, a prompt sentence including a natural-language query, input the prompt sentence to a generative AI model including a generative language model, obtain structured condition information representing selection conditions inherent in the prompt sentence, convert the structured condition information into query control information including evaluation-criterion information, sorting-condition information, and extraction-limit information, and perform search processing and ranking processing on the numerical evaluation information and the attribute information stored in the storage device based on the query control information to thereby search a candidate subject group satisfying the structured condition information and update the candidate subject list information; and to transmit the candidate subject list information corresponding to the searched candidate subject group to the operation terminal and present the candidate subject list information on a user display screen of the operation terminal.

This enables the server to technically improve data processing efficiency and system responsiveness by (i) reducing runtime data conversion through pre-organized and normalized structured information, (ii) offloading complex multi-dimensional evaluation to a trained evaluation model on a dedicated machine learning computation resource, and (iii) transforming natural-language prompt sentences into machine-interpretable structured condition information and query control information that allow the processor to execute optimized search and ranking operations over large-scale stored data, thereby lowering computational overhead, improving memory and cache utilization, and providing low-latency, accurate candidate list generation.

The term “processor” refers to a hardware computation element, such as a central processing unit or a graphics processing unit, configured to execute instructions to perform data acquisition, data processing, model execution, searching, and communication operations in the system.

The term “storage device” refers to a non-transitory computer-readable medium, such as a magnetic storage device, a semiconductor memory device, or a solid-state storage device, configured to store structured information, numerical evaluation information, model parameters, and candidate subject list information.

The term “subject” refers to an entity to be evaluated by the system, such as an individual participant or performer, for which behavior information, viewing information, and attribute information are collected and processed.

The term “behavior information” refers to time-series or event-based performance information of a subject, including but not limited to numerical records of actions, achievements, and physical metrics obtained from sensors, logs, or performance records.

The term “viewing information” refers to media-related information associated with a subject, including but not limited to identifiers or files of moving image data, still image data, or other audiovisual content representing the subject's performance.

The term “structured information” refers to digitized data that is organized according to a defined schema, including fields for behavior information, viewing information, attribute information, and numerical information, such that each record can be consistently accessed and processed by the processor.

The term “information organization processing” refers to a series of processing operations applied to structured or semi-structured data, including but not limited to format checking, type validation, missing-value processing, and consistency checking, in order to generate organized structured information suitable for subsequent analysis.

The term “information format checking” refers to processing in which the processor verifies that input data conforms to predetermined formats, data types, and value ranges, and detects inconsistencies, corrupt records, or incompatible encodings.

The term “missing-value processing” refers to processing in which the processor detects absent or invalid data elements in structured information and handles them, for example by discarding records, substituting default values, or estimating replacement values according to predefined rules.

The term “organized structured information” refers to structured information that has been subjected to information organization processing, such that its data types, formats, and value ranges meet predetermined requirements for feature generation and model input.

The term “attribute information” refers to descriptive information of a subject, such as category, role, position, demographic data, or classification labels, which is not limited to numerical form and can include categorical or text-based values.

The term “numerical information” refers to quantitative data associated with a subject, such as counts, rates, distances, durations, and scores, which can be directly processed by numerical computation and machine learning algorithms.

The term “feature information” refers to a set of numerical representations derived from attribute information and numerical information, obtained by applying normalization, encoding, or other transformations, and configured to be input to a machine learning model.

The term “normalization processing” refers to processing in which numerical information is scaled or transformed, for example by standardization, min-max scaling, or other statistical transformations, in order to adjust ranges or distributions for use by the evaluation model.

The term “encoding processing” refers to processing in which non-numerical attribute information, such as categorical or textual values, is converted into numerical representations, for example through one-hot encoding, embedding vectors, or index mappings.

The term “trained evaluation model” refers to a machine-learning-based computational model whose parameters have been adjusted through a training process using training data, and which, when executed, outputs numerical evaluation information representative of the abilities or characteristics of subjects.

The term “machine learning computation resource” refers to a hardware or virtualized computation environment, such as a processor, an accelerator, or a cluster thereof, configured to execute machine learning models, including the trained evaluation model, in order to perform numerical inference or training.

The term “numerical evaluation information” refers to one or more numerical values generated by the trained evaluation model based on feature information, representing an assessment of a subject, such as an overall evaluation score, a potential score, or related indicators.

The term “selection condition” refers to a logical constraint or range applied to the attributes or evaluation results of subjects, including but not limited to a role condition, an age condition, and a performance condition, used to extract a subset of subjects as a candidate subject group.

The term “role condition” refers to a selection condition that specifies required or desired roles or categories of subjects, such as particular functional positions, responsibilities, or classifications.

The term “age condition” refers to a selection condition that specifies a range or threshold for age-related information of subjects, such as upper and lower limits of chronological age or experience.

The term “performance condition” refers to a selection condition that specifies constraints on performance-related metrics of subjects, such as minimum counts, averages, rates, or evaluation scores.

The term “candidate subject group” refers to a subset of subjects selected from all stored subjects based on one or more selection conditions, wherein each subject in the subset satisfies the specified conditions.

The term “candidate subject list information” refers to data representing a list of subjects in a candidate subject group, including identifiers, attributes, numerical evaluation information, and a ranking order determined based on defined criteria.

The term “operation terminal” refers to an information processing apparatus, such as a client computer, a mobile device, or a terminal device, used by a user to transmit data and prompt sentences to the server and to receive and display candidate subject list information.

The term “user display screen” refers to a graphical user interface or visual output area on the operation terminal, configured to present candidate subject list information, detailed subject information, and other related data to the user.

The term “prompt sentence” refers to a text string expressed in natural language and input by a user, which describes a query, an instruction, or a requirement related to subject selection, and which is provided as input to a generative AI model.

The term “natural-language query” refers to a prompt sentence that expresses information retrieval or selection criteria in a human language, without being restricted to a predefined query syntax or structured query language.

The term “generative AI model” refers to an artificial intelligence model capable of generating or transforming text or structured data in response to an input, including but not limited to a generative language model that processes prompt sentences to output structured condition information.

The term “generative language model” refers to a language-processing model that receives tokenized text as input and generates, predicts, or transforms sequences of tokens, sentences, or structured representations, typically implemented with neural network architectures such as sequence models or transformer models.

The term “structured condition information” refers to data that explicitly represents selection conditions extracted from a prompt sentence, including fields, operators, and values corresponding to constraints on attributes or evaluation information of subjects.

The term “query control information” refers to information derived from structured condition information, including evaluation-criterion information, sorting-condition information, and extraction-limit information, and used to control how search processing and ranking processing are performed on stored data.

The term “evaluation-criterion information” refers to information specifying which numerical evaluation information or metrics are to be used as primary or secondary criteria when ranking or filtering subjects.

The term “sorting-condition information” refers to information that specifies the order and direction of sorting, such as ascending or descending order of particular numerical evaluation information or attributes, when generating candidate subject list information.

The term “extraction-limit information” refers to information that specifies limits on the number or scope of subjects to be extracted or returned as search results, such as a maximum number of entries or a range of ranking positions.

The term “search processing” refers to operations in which the processor accesses the storage device and retrieves subjects that satisfy given structured condition information or query control information.

The term “ranking processing” refers to operations in which the processor determines an order of subjects based on numerical evaluation information, attribute information, or evaluation-criterion information, and assigns or computes ranks accordingly.

The term “emotion processing function” refers to a processing function or module that calculates emotion-state information based on one or more inputs, such as numerical evaluation information, search results, or other contextual data, and outputs emotional adjustment information.

The term “emotion-state information” refers to data representing a state or tendency associated with an emotion or preference, which can be quantified and used as input to further processing in the system.

The term “emotional adjustment information” refers to information derived from emotion-state information and used to adjust priorities, weights, or rankings of subjects in a candidate subject group.

The term “supplementary explanation information” refers to natural-language or structured descriptions generated by the generative AI model based on a prompt sentence and candidate subject list information, which provide additional explanations, summaries, or recommendations related to the presented subjects.

In one embodiment, a server, a terminal, and a user cooperate to implement the claimed system. The server includes at least one processor, a main memory, a non-transitory storage device, a network interface, and optionally a dedicated machine learning computation resource such as a graphics processing unit. The terminal includes a processor, a display device, an input device, and a communication module. The server and the terminal are connected via a communication network using standardized communication protocols.

The server uses general-purpose server hardware, for example a multi-core central processing unit and an optional graphics processing unit, and executes an operating system and server software such as a web server and an application server. The server stores structured information, numerical evaluation information, model parameters, and candidate subject list information in a database management system and a file storage system. The server uses a machine learning framework, such as a deep learning framework, and a natural-language processing framework suitable for implementing a generative AI model.

The terminal executes a client application, for example a web application implemented with a component-based user interface framework, or a native mobile application. The terminal provides a user display screen, input forms, and interactive controls to allow the user to upload data, enter a prompt sentence, and view candidate subject list information. The terminal communicates with the server through web application programming interfaces using structured message formats.

The user operates the terminal to register subjects and to provide behavior information and viewing information for the subjects. The user, for example, selects files containing performance statistics and motion image data, and enters metadata such as subject identifiers, roles, and demographic attributes. The terminal sends the selected files and the metadata to the server using a multipart request or an equivalent protocol.

The server receives the behavior information and the viewing information from the terminal, and the processor stores this information as structured information in the storage device. The server, for example, stores time-series performance records as rows in relational tables with columns for subject identifiers, timestamps, event types, and values, and stores references to motion image files or image sequences as file paths or object identifiers in another table. The server creates indices on primary keys and frequently queried fields to accelerate subsequent search operations.

The server performs information organization processing on the structured information. The processor performs information format checking by verifying that each record conforms to predefined schemas, data types, and value ranges. The processor, for example, verifies that numerical fields contain valid numbers within specified bounds, that timestamps are in a valid time format, and that foreign key references correspond to existing subject records. The processor identifies missing values, inconsistent formats, and out-of-range values.

The server performs missing-value processing by applying predefined rules. The processor, for example, discards records with critical missing identifiers, replaces missing numerical performance metrics with statistical estimates such as per-subject averages or median values, and normalizes units of measurement over the entire dataset. The processor marks cleaned records with status flags and writes the organized structured information back to the storage device. Because this organization processing is performed once at ingestion and stored persistently, later search and evaluation operations avoid repeated ad hoc format conversions, thereby reducing processor cycles and memory allocation overhead.

The server extracts attribute information and numerical information from the organized structured information. The processor identifies attributes such as role, category, age, and affiliation, and separates them from raw performance metrics such as counts, distances, speeds, and rates. The processor applies normalization processing to numerical information, for example using z-score normalization or min-max scaling, to generate normalized values that are less sensitive to scale differences. The processor applies encoding processing to attribute information, for example by mapping categorical roles to one-hot vectors or learned embedding vectors. The processor then concatenates normalized numerical values and encoded attribute vectors to form feature information as dense numerical vectors.

The server inputs the feature information to a trained evaluation model executed on a machine learning computation resource. In one embodiment, the trained evaluation model is a feedforward neural network including an input layer, a plurality of hidden layers, and an output layer. Each hidden layer includes a linear transformation and a nonlinear activation function, such as a rectified linear unit. Some hidden layers may include batch normalization and dropout to stabilize training and prevent overfitting. The output layer generates one or more outputs, such as an overall evaluation score and a potential score.

The server trains the evaluation model in advance using training data that includes historical feature information and target labels representing expert assessments or future performance indicators. The processor performs training using a supervised learning algorithm. The processor initializes weights, defines a loss function such as a mean squared error or a cross-entropy loss depending on the task, and performs backpropagation to compute gradients of the loss with respect to the model parameters. The processor updates the weights using an optimization method such as stochastic gradient descent or an adaptive optimization algorithm. The processor may apply data augmentation, for example by adding noise to numerical features or by constructing synthetic combinations of attributes, to improve robustness. When the training converges, the server stores the resulting model parameters in the storage device.

During inference, the server executes only the forward pass of the trained evaluation model on the feature information. The processor performs matrix multiplications, bias additions, and activation function evaluations to calculate numerical evaluation information for each subject. Because the feature information is normalized and encoded in a consistent manner, the model operations are numerically stable and well-suited for vectorized execution on a graphics processing unit, which improves throughput and reduces inference latency compared to non-vectorized rule-based computations. The processor stores the numerical evaluation information, including evaluation scores and potential scores, in association with subject identifiers in the storage device.

The server extracts a candidate subject group based on selection conditions including a role condition, an age condition, and a performance condition. The processor constructs search queries using the numerical evaluation information and the attribute information. For example, the processor may apply conditions “role =specific role,” “age <=threshold,” and “evaluation score >=threshold” to the stored tables. The processor executes these queries using index scans or range scans, depending on the database engine, and obtains a candidate subject group that satisfies the conditions. The processor then executes ranking processing in which the candidates are sorted by at least one evaluation score field in descending order. The processor generates candidate subject list information that stores identifiers, primary attributes, and evaluation scores in order of rank.

The server receives a prompt sentence from the terminal. The user enters a natural-language query into an input field in the terminal, such as:
“List up players under 20 years old who have scored at least 10 goals.”
or
“Show midfielders between 22 and 25 years old with more than 8 assists and a high evaluation score.”

The terminal encapsulates the prompt sentence in a request message and sends it to the server. The server receives the prompt sentence by the processor and forwards the prompt sentence to a generative AI model. In one embodiment, the generative AI model is a transformer-based generative language model implemented using a sequence of encoder and decoder blocks or decoder-only blocks. The model uses an embedding layer to convert input tokens into vector representations, multiple self-attention layers to model dependencies among tokens, and feedforward sublayers to transform representations.

The server stores the parameters of the generative AI model in the storage device and executes the model on the machine learning computation resource. The processor tokenizes the prompt sentence into subword tokens using a predetermined tokenizer, maps each token to an embedding vector, and processes the vectors through the transformer layers. The self-attention mechanism computes attention weights over tokens, which allows the model to infer relationships such as “under 20 years old” corresponding to an age condition and “at least 10 goals” corresponding to a performance condition.

The server obtains structured condition information from the output of the generative AI model. In one embodiment, the generative AI model is trained or configured to output a constrained sequence that represents a set of fields, operators, and values. The processor parses this sequence into structured condition information indicating, for example, that a field corresponding to age has an upper bound constraint and that a field corresponding to goals has a lower bound constraint. The processor also derives evaluation-criterion information (for example, “sort by evaluation score”), sorting-condition information (for example, “descending order”), and extraction-limit information (for example, “top 50 results”) from the generated structure.

The server converts the structured condition information into query control information. The processor maps fields in the structured condition information to specific columns or indices in the database and constructs an executable internal representation of a query plan. This representation includes necessary predicates, sort keys, and result limits. Because the generative AI model produces structured condition information with explicit fields and operators, the processor does not rely on generic string matching or ad hoc parsing, which reduces ambiguity and simplifies query planning.

The server performs search processing and ranking processing on the numerical evaluation information and the attribute information in the storage device based on the query control information. The processor executes one or more queries using index-based lookups and range filters. The processor applies the sorting-condition information to produce a ranking, and applies the extraction-limit information to restrict the number of returned subjects. The processor updates the candidate subject list information or generates a new list tailored to the prompt sentence.

The server transmits the candidate subject list information to the terminal. The processor serializes the list into a message and sends it over the network interface. The terminal receives the candidate subject list information and renders it on the user display screen. The terminal, for example, displays a table with columns for name, age, role, evaluation score, and performance metrics, and allows the user to select a row to view detailed information. The terminal may display the interpreted conditions corresponding to the original prompt sentence so that the user can confirm how the system understood the query.

In some embodiments, the server further executes an emotion processing function. The processor calculates emotion-state information based on aggregated evaluation scores, historical selection patterns, or external feedback signals. The processor then derives emotional adjustment information that modifies weights or priorities of certain attributes when ranking the candidate subject group. The processor applies this emotional adjustment information to the numerical evaluation information during ranking processing, thereby adjusting the order of the candidate subject list information in a consistent and repeatable manner. This processing is performed according to predefined algorithms or learned patterns, not according to ad hoc human edits.

In some embodiments, the server uses the generative AI model to generate supplementary explanation information. The processor inputs a prompt sentence including an evaluation instruction, such as “Explain why these players are recommended,” and includes key fields from the candidate subject list information. The generative AI model processes this input and outputs a textual explanation that references evaluation scores, roles, and conditions. The processor sends this supplementary explanation information to the terminal and displays it along with the candidate subject list information. This explanation helps the user understand system decisions, while the underlying technical operations remain deterministic in terms of database queries and model inference.

The described configuration provides technical effects that go beyond mere automation of human decision-making. Because the server normalizes and encodes data once at ingestion and stores organized structured information, later queries use consistent, preprocessed data structures, which reduces repeated parsing and type conversion operations. This directly decreases central processing unit time and memory allocations and improves cache locality. The use of a trained evaluation model with vectorized operations exploited by a graphics processing unit or equivalent accelerator increases throughput for generating numerical evaluation information compared to non-optimized rule-based implementations.

Furthermore, the cooperation between the generative AI model and the search engine improves computing efficiency. Instead of executing multiple broad queries or scanning large portions of the database, the server derives precise query control information from the prompt sentence and performs targeted searches with index-supported range predicates. This reduces the number of rows read from storage, lowers input/output operations, and diminishes network traffic between the database engine and the application logic. As a result, the server responds to complex natural-language prompt sentences with low latency even when the underlying dataset is large.

The system also improves accuracy and stability of evaluation. The trained evaluation model uses many features simultaneously and learns non-linear relationships that are not captured by simple human-designed formulas. During training, the processor minimizes an explicit loss function over a large dataset, and the resulting weights encode nuanced patterns. This enables the server to generate numerical evaluation information with lower prediction error and higher consistency than hand-crafted scoring rules. The emotion processing function further adjusts rankings according to systematically computed emotional adjustment information rather than inconsistent human bias.

The system performs operations that are not conventionally performed manually by a human. For example, the generation of feature information involves high-dimensional vector transformations and encoding schemes that a human cannot practically replicate at scale. The evaluation model and the generative AI model operate on vectorized token and feature representations and perform matrix multiplications and attention computations that exploit specialized hardware. The integration of these models into the database query pipeline, through structured condition information and query control information, constitutes a non-conventional combination that improves technical performance of the server as a data processing machine.

Alternative embodiments may vary the configuration while maintaining the core technical features. The server may use a different type of database, such as a column-oriented database or a key-value store, as long as it supports index-based search according to structured condition information. The evaluation model may be a recurrent neural network, a gradient-boosted decision tree ensemble, or another machine learning architecture, provided that the processor generates feature information and executes the model on a machine learning computation resource to produce numerical evaluation information. The generative AI model may be implemented as an encoder-only or decoder-only transformer with different numbers of layers, attention heads, and hidden units, or may be replaced with another generative model that outputs structured condition information from a prompt sentence.

The terminal may be a desktop computer, a tablet device, or another type of client device. The user may interact with the system using a web browser, a dedicated application, or another user interface framework. The server may run in a cloud environment or on-premise hardware. Regardless of these variations, the server continues to execute the described organization processing, feature generation, model inference, prompt interpretation, query control generation, and search and ranking operations to achieve improved processing speed, evaluation accuracy, data management, and computational efficiency.

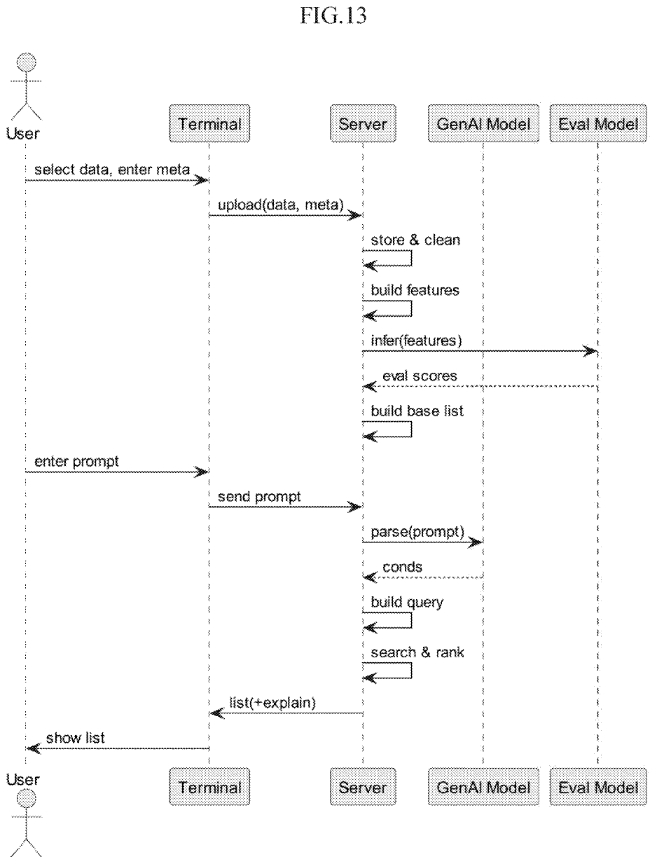

The following describes the processing flow using FIG. 13.

### Step 1:

The user prepares subject data on the terminal. The user selects files containing behavior information, such as tabular performance logs, and viewing information, such as motion image files, and inputs metadata including subject name, role, and age. The input is raw files and textual entries, and the output is a structured upload request containing the selected files and metadata. The terminal packages the files and metadata into a network message and sends the message to the server over a communication network.

### Step 2:

The server receives the upload request from the terminal. The input is the network message containing raw behavior information, viewing information, and metadata. The server validates authentication tokens, checks file sizes and types, and writes metadata into database tables while storing large media files in a file storage system. The output is structured information stored in the storage device, including references linking metadata records to file locations. The server creates or updates index entries on identifiers and frequently used attributes to optimize later access.

### Step 3:

The server performs information format checking on the structured information. The input is newly stored structured records of behavior information and viewing information. The server verifies data types, required fields, and value ranges; for example, the server confirms that numerical metrics are valid numbers, that timestamps are parseable, and that subject identifiers match registered subjects. The server flags records with inconsistencies or missing values. The output is categorized data consisting of valid records and records requiring correction, with associated status flags.

### Step 4:

The server executes missing-value processing and normalization. The input is the categorized data from format checking, including records with missing or anomalous entries. The server applies predefined rules to handle missing values, such as computing per-subject or global averages to fill gaps, discarding unusable records, and converting units (for example, meters to kilometers). The server also normalizes numerical fields, for example by computing z-scores or min-max scaled values using aggregate statistics. The output is organized structured information, where all required fields conform to the defined schema and normalized scales. The server stores this organized structured information back into the database with updated flags.

### Step 5:

The server extracts attribute information and numerical information to generate feature information. The input is the organized structured information for all subjects. The server separates categorical attributes, such as role and affiliation, from numerical performance metrics, such as counts, distances, and rates. The server encodes categorical attributes into numerical representations, such as one-hot vectors or index-based embeddings, and concatenates these encodings with normalized numerical metrics. Through this data transformation, the server performs vector construction operations on arrays of values. The output is feature information, represented as dense numerical vectors associated with each subject.

### Step 6:

The server executes the trained evaluation model to calculate numerical evaluation information. The input is the feature information for one or more subjects. The server loads parameters of a pre-trained neural network model from the storage device into memory and executes the model on a central processing unit or a machine learning computation resource. The server performs matrix multiplications, bias additions, and activation function evaluations across multiple layers of the network. The output is numerical evaluation information, such as an overall evaluation score and a potential score for each subject. The server writes these scores and related indicators into the database, indexed by subject identifiers.

### Step 7:

The server constructs a candidate subject group based on predefined selection conditions. The input is the stored numerical evaluation information and attribute information. The server formulates search predicates representing a role condition, an age condition, and a performance condition, and executes database queries using indices to retrieve records that satisfy these predicates. The server then applies sorting operations based on evaluation scores or other metrics to rank the resulting subjects. The output is candidate subject list information, in which each entry includes identifying fields, key attributes, and evaluation scores in descending order of priority.

### Step 8:

The user enters a prompt sentence on the terminal. The input is the user's natural-language query, for example:
“List up players under 20 years old who have scored at least 10 goals.”
or
“Show midfielders between 22 and 25 years old with more than 8 assists and a high evaluation score.”
The terminal captures the prompt sentence via an input widget and forms a request message containing the text. The output is a network request addressed to the server, carrying the prompt sentence and optional context parameters.

### Step 9:

The server forwards the prompt sentence to the generative AI model and obtains structured condition information. The input is the text of the prompt sentence received from the terminal. The server tokenizes the prompt sentence, converts tokens into embeddings, and processes them through a transformer-based generative language model running on the processor or a machine learning computation resource. The model performs self-attention and feedforward operations to infer semantic constraints, such as age limits and performance thresholds. The output is structured condition information, encoding fields (for example, age, goals, role), operators (for example, less than or equal, greater than or equal, equality), and values derived from the prompt sentence.

### Step 10:

The server converts the structured condition information into query control information. The input is the structured condition information from the generative AI model. The server maps abstract field names to concrete database columns, determines which evaluation metrics to use as primary sorting keys, and sets extraction limits (for example, a maximum number of results). The server composes an internal query plan that specifies selection predicates, sort orders, and result limits. The output is query control information, including evaluation-criterion information, sorting-condition information, and extraction-limit information, ready to drive efficient database operations.

### Step 11:

The server executes search processing and ranking processing based on the query control information. The input is the query control information together with stored numerical evaluation information and attribute information. The server issues one or more database queries using the specified predicates and sort keys and utilizes indices to minimize full-table scans. The server then performs ranking according to the evaluation-criterion information and truncates the result set based on the extraction-limit information. The output is an updated candidate subject group and corresponding candidate subject list information, tailored to the contents of the prompt sentence.

### Step 12:

The server optionally applies emotional adjustment information to refine ranking. The input is the candidate subject list information, numerical evaluation information, and emotion-state information, if available. The server computes emotional adjustment information, such as weighting factors for particular attributes or scores, and applies these factors to modify ranking scores for each subject. The server re-sorts the list based on the adjusted scores. The output is emotion-adjusted candidate subject list information, where priorities reflect both numerical evaluation information and systematically computed emotional adjustment information.

### Step 13:

The server optionally generates supplementary explanation information using the generative AI model. The input is the finalized candidate subject list information and an internally composed or user-provided prompt sentence, such as “Explain why these candidates are recommended.” The server passes a representation of the candidate list and the instruction text to the generative AI model. The model performs additional language generation operations, using attention over list attributes and evaluation scores, to produce an explanation in natural language. The output is supplementary explanation information that describes the reasons for selection and ranking in human-readable form.

### Step 14:

The server transmits the resulting information to the terminal. The input is the candidate subject list information, and optionally the supplementary explanation information. The server serializes these data structures into a response message and sends the message through the network interface. The output is a response delivered to the terminal, containing all fields required for display, including identifiers, attributes, evaluation scores, and explanatory text if present.

### Step 15:

The terminal presents the candidate subject list information and supplementary explanation information to the user. The input is the response message from the server. The terminal parses the message, populates user interface components with list entries, and renders tables, detail views, and explanations on the user display screen. The terminal may allow the user to sort locally by displayed fields, to open details for individual subjects, or to issue a new prompt sentence based on the visible results. The output is an updated visual representation on the display and any subsequent user actions that may trigger a new processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented decision support systems that evaluate human subjects, such as workers in industrial environments or players in competitive activities, rely mainly on fixed-function algorithms and static rule sets. These systems typically process numerical performance data in isolation, without deeply integrating heterogeneous information such as motion patterns extracted from images, emotional or fatigue states, and high-level planning constraints. As a result, the systems often produce coarse or brittle evaluations and recommendations that do not adapt well to changing conditions, complex trade-offs, or user-specific preferences.

Further, although generative AI models have recently been used to generate natural-language summaries, existing systems generally invoke such models in an ad hoc manner: a human operator manually crafts a prompt, sends it to the model, and then informally interprets the free-form output. The underlying computer system does not structure the interaction between low-level feature computation and high-level generative reasoning, and does not systematically generate prompts based on machine-processable indices. Because of this, the computing resources of the generative AI model are not efficiently exploited, and the quality and reproducibility of the results strongly depend on human expertise in prompt design.

In addition, known systems do not provide a unified computational framework that (i) continuously acquires and stores behavior information and state information from multiple sensing modalities, (ii) converts such information into machine-oriented feature data and quantitative indices, (iii) automatically generates prompt sentences that instruct a generative AI model to perform specific evaluation or plan generation tasks, and (iv) returns the generative AI model's output into the structured decision loop as candidate plans that can be visualized, compared, updated, and re-queried via additional prompts. Consequently, the underlying computer technology suffers from limitations in scalability, adaptability, and explainability: it is difficult to maintain consistent evaluation quality across many subjects, to re-use computed features in different decision scenarios, and to interactively refine results without re-implementing application logic.

There is therefore a need for an improved computer-implemented system and server architecture that tightly couples feature-level computation with prompt-driven generative reasoning. Such a system should automatically synthesize prompt sentences from computed feature data and indices, feed both structured and unstructured inputs to a generative AI model, and transform the model's outputs into machine-readable options for subject evaluation and placement planning. By doing so, the system should improve the way in which computers process complex heterogeneous data, orchestrate calls to generative AI models, and support iterative, data-driven decision making with reduced dependence on manual prompt engineering, while providing enhanced transparency and controllability of the computational pipeline.

The specific processing by the specific processing unit 290 of the data processing device 12 in Application Example 2 is realized by the following means.

The present invention provides a server comprising a processor configured to acquire and store behavior information and state information of a subject from one or more sensing devices, to preprocess the behavior information and the state information and convert the behavior information and the state information into feature data in order to calculate an ability index and a state index of the subject, to automatically generate a prompt sentence that instructs a generative AI model to perform evaluation of the subject or to generate a placement plan based on the feature data and at least one of the ability index and the state index, to input the prompt sentence and at least one of the feature data, the ability index, and the state index into the generative AI model so as to cause the generative AI model to execute analysis processing, to generate an ability evaluation result of the subject and one or more candidate placement plans by using an analysis result output from the generative AI model, and to output visualization information including the analysis result and the one or more candidate placement plans and provide support information that adopts or modifies at least a part of the one or more candidate placement plans in response to instruction input from a user. This enables improvement of the underlying computer technology by establishing a structured, processor-implemented pipeline that transforms heterogeneous sensor data into machine-readable feature data and indices, programmatically synthesizes and manages prompt sentences for a generative AI model, integrates the model's outputs back into a computable set of candidate plans, and supports iterative user interaction and re-querying, thereby enhancing the efficiency, adaptability, and consistency of computer-based evaluation and decision support.

The term “subject” refers to a human individual whose behavior information and state information are acquired, evaluated, and used for generating placement plans or other decision outputs.

The term “behavior information” refers to information representing actions or activities of the subject, including but not limited to motion information, positional information, operation logs, and image or video information from which such actions can be derived.

The term “state information” refers to information representing a physical, mental, or contextual state of the subject, including but not limited to emotion information, fatigue information, stress level information, and other condition-related indicators.

The term “feature data” refers to data obtained by preprocessing and transforming raw behavior information and state information into numerical or symbolic representations suitable for machine processing, including feature vectors, statistical summaries, and encoded descriptors.

The term “ability index” refers to a quantitative indicator derived from the feature data that represents an estimated capability, skill level, or performance level of the subject with respect to one or more tasks.

The term “state index” refers to a quantitative indicator derived from the feature data that represents an estimated condition of the subject, such as an emotion level, fatigue level, or stress level.

The term “generative AI model” refers to an information processing model implemented by a computing apparatus that generates outputs such as natural-language text, structured data, or other content in response to input data and a prompt sentence, based on learned statistical relationships.

The term “prompt sentence” refers to a machine-processable input expression, including natural-language text or structured text, that instructs the generative AI model to perform a specified analysis, evaluation, or generation task using supplied data.

The term “analysis processing” refers to processing executed by the generative AI model or other computational components to interpret input data, infer attributes, generate evaluation results, or create candidate placement plans.

The term “ability evaluation result” refers to information indicating a computed assessment of the subject's abilities, including but not limited to numerical scores, rankings, classifications, or descriptive evaluations derived from analysis processing.

The term “candidate placement plan” refers to a plan, assignment, or configuration that specifies how one or more subjects should be allocated to roles, tasks, locations, or positions, as generated or refined by analysis processing.

The term “visualization information” refers to information formatted for human perception that represents analysis results, ability evaluation results, and candidate placement plans, including tables, charts, graphs, diagrams, and explanatory text.

The term “support information” refers to information provided to a user to facilitate decision making, including proposals for adopting or modifying candidate placement plans, explanations of analysis results, and suggestions for alternative configurations.

The term “user” refers to a human operator who interacts with the system, views visualization information, inputs instruction data or prompt sentences, and adopts or modifies candidate placement plans.

The term “terminal device” refers to an information processing apparatus, such as a client computer, mobile device, or display device, that communicates with the server, presents visualization information to the user, and receives input from the user.

The term “sensing device” refers to a hardware apparatus configured to capture behavior information or state information of the subject, including imaging devices, motion sensors, physiological sensors, and logging devices.

The term “instruction input” refers to data received from the user via the terminal device indicating operations such as selection, adoption, modification, or rejection of candidate placement plans, or requests for additional analysis.

The term “additional prompt sentence” refers to a prompt sentence that is input after presentation of initial visualization information and that instructs the generative AI model to perform additional analysis, refinement, or generation of alternative candidate placement plans.

In one embodiment, a server, a terminal, and a plurality of sensing devices cooperate to implement the claimed system. The server includes at least one processor, a memory, a communication interface, and a non-transitory storage medium storing instructions. The server executes the instructions to implement acquisition of behavior information and state information, computation of feature data, calculation of indices, generation and management of prompt sentences for a generative AI model, invocation of the generative AI model, generation of candidate placement plans, and provision of visualization information and support information. The terminal includes at least one processor, a display, an input interface, a camera and optionally a microphone. The sensing devices include imaging devices, motion sensors, and other detectors configured to capture behavior information and state information of a subject in a real environment such as a factory floor or a sports field.

Server uses a set of software modules including an operating system, a database management system, a numerical computation library, a machine learning framework such as a generic tensor computation framework, a computer vision library such as a general image processing library, and a generative AI client library to access a remote generative AI model. Server further stores in the memory one or more trained neural network models for feature extraction, ability estimation, state estimation, and recommendation. These models include, for example, convolutional neural networks for image-based motion and facial expression recognition, recurrent or transformer-based networks for temporal sequence analysis, and a feedforward network for combining multiple indices into a single placement suitability score.

Server acquires behavior information by receiving video streams from imaging devices positioned in a factory or stadium, or by receiving pre-captured video files and motion sensor logs. Server decodes the video streams and uses the image processing library to perform frame extraction, color space conversion, geometric normalization and background subtraction. Server then applies an object detection and tracking model, such as a convolutional neural network-based detector followed by a tracking algorithm, to detect each subject and associate a unique track identifier to each subject. Server computes trajectories, velocities, acceleration, dwell times at positions, and event counts (such as pick, place, shot, pass, or inspection) from the tracked paths. Server stores these features as behavior information records in the database, with fields including subject identifier, time stamp, spatial coordinates, and event labels.

Server acquires state information by processing facial images, voice signals, and physiological sensor outputs. Terminal captures the subject's face via its camera and, optionally, captures audio via its microphone, during the subject's activity or while a user watches a recorded activity. Terminal sends the captured data to server. Server uses a convolutional neural network trained for facial emotion recognition to classify each face crop into emotion categories such as joy, surprise, anger, or fatigue. Server computes an emotion score vector and aggregates scores over time to obtain a state index such as a stress level or fatigue level. Server also processes motion patterns such as reduced speed or increased hesitation as additional indicators of fatigue, thereby deriving a composite state index from both behavior information and emotion information.

Server preprocesses behavior information and state information to create feature data suitable for subsequent computation. Server normalizes values, resamples temporal sequences to fixed lengths, and performs dimensionality reduction where appropriate. In one embodiment, server represents each subject by a high-dimensional feature vector that concatenates (i) motion features such as average cycle time, path length, jerk, and error frequency, (ii) performance features such as goals, assists, distance covered, or inspection accuracy, and (iii) state features such as average stress level and variance of emotional responses. Server stores these feature vectors in a feature table indexed by subject and time period.

Server calculates an ability index and a state index by applying trained neural network models to the feature vectors. For example, server uses a feedforward neural network having multiple fully connected layers with rectified linear unit activation, batch normalization, and dropout. Server inputs the motion and performance features to this network to output an ability index, such as an efficiency score or performance score between 0 and 100. Server also uses a separate network or output branch that takes emotion-related features and behavioral variability as input and outputs a state index such as a fatigue score or stress score.

Server trains these networks offline using supervised learning with historical labels, using a loss function such as mean squared error between predicted scores and expert ratings, and server performs weight updates via gradient descent with backpropagation. Server optionally uses data augmentation techniques, such as adding noise to motion trajectories or performing temporal cropping, to improve robustness and generalization.

Server generates a prompt sentence that instructs a generative AI model to perform an evaluation or generate a placement plan. Server constructs the prompt sentence programmatically rather than relying on manual user input alone, based on the computed feature data, ability index, and state index. In one embodiment, server uses a prompt template stored in memory and fills in variable parts with actual values or summarized descriptions.

For example, server generates a prompt sentence such as:
“You are a production planner. Based on the following worker efficiency scores, fatigue scores, and station requirements, generate an optimal placement plan and explain your reasoning.”

Server then appends a structured textual representation of feature data and indices, for example:
“Worker A: efficiency score 88, fatigue score 20; Worker B: efficiency score 75, fatigue score 60; Stations: Assembly (requires high efficiency, low fatigue), Inspection (requires accuracy).”

In another embodiment related to sports, server generates a prompt sentence such as:
“Based on the last three seasons'data, evaluate the potential of players under 20 and recommend the top 5 with explanations.”

Server thereby directly connects computed numerical indices to the generative AI model via a prompt sentence, in a consistent and reproducible manner.

Server inputs the generated prompt sentence and associated data into the generative AI model through a communication interface. In one implementation, server calls a remote language model service by sending a request comprising the prompt sentence and a compact representation of the feature data and indices. Server receives from the generative AI model a natural-language output containing an analysis result, such as an explanation of a subject's strengths and weaknesses, and a candidate placement plan, such as a mapping between subjects and roles or tasks.

Server parses the generative AI model's output using deterministic parsing rules and pattern matching. Server identifies explicit placement assignments, extracted as subject-to-position pairs, and evaluation statements, extracted as qualitative and quantitative assessments. Server converts these into structured records stored in a placement plan table. Server may apply additional constraints such as maximum workload per subject or capacity per station using an algorithmic post-processing step, for example a constraint satisfaction or greedy optimization algorithm, to validate and, if necessary, adjust the candidate placement plans.

Server generates visualization information based on both the computed indices and the candidate placement plans. Server prepares data structures suitable for graphical representation, such as time series of ability indices, distributions of state indices, and a graph or matrix representing subject-task assignments. Server sends these data to terminal, which renders charts, tables, or diagrams on its display using a graphical library. For example, terminal displays a table of workers with columns for efficiency score, fatigue score, and recommended station, and displays a floor map of a factory with worker icons placed at suggested stations. For sports scenarios, terminal displays radar charts for each player showing sub-skills and overlays the generative AI model's descriptive commentary beneath each chart.

Terminal also displays the prompt sentences that server used or that user entered, so that user can understand how the generative AI model was instructed. Terminal provides an input field for user to enter an additional prompt sentence, enabling interactive refinement. For example, user may enter:
“Given the current efficiency and fatigue indexes, generate an alternative placement that reduces fatigue, even if overall throughput decreases slightly.”
or
“From the current shortlist, recommend three players who best fit a high-pressing, fast-transition style. Explain your choice using their data.”

Terminal sends the additional prompt sentence to server together with references to the relevant feature data and indices. Server then constructs a combined prompt by adding structured context to the user's prompt sentence, such that the generative AI model receives both the high-level instruction and the underlying numerical data. Server uses this to obtain refined analysis results and updated candidate placement plans.

Server thereby implements a closed loop of computation in which raw sensor data is transformed into feature data and indices; prompt sentences are automatically synthesized from the indices; a generative AI model is invoked with the prompt sentences and data; and the resulting natural-language output is translated back into structured decision variables. This specific organization of the computational pipeline improves computer technology in several ways.

First, server reduces communication load and latency by transmitting compact indices and summaries, rather than full raw data, to the generative AI model. This improves processing speed and allows the model to focus on high-level reasoning while the computationally intensive feature extraction occurs locally using optimized numerical libraries. Second, server improves evaluation accuracy and consistency by reusing the same neural network structures and learned parameters for feature extraction and index calculation, rather than ad hoc manual scoring. Third, server enhances data management by storing feature vectors, indices, prompt sentences, and generative outputs in related data structures that can be queried, audited, and reused across different decision scenarios. This structure allows server to avoid recomputing features for similar prompts and to cache intermediate results.

Moreover, server causes the generative AI model to operate under explicit, machine-generated constraints rather than performing free-form text generation disconnected from the underlying data. Server formulates prompt sentences with explicit instructions and embedded indices, so that the generative AI model uses non-conventional processing paths, such as balancing ability indices against state indices under specific constraints, which a human operator would not manually compute at scale. This arrangement differs from a mere automation of human decision making because server leverages statistical models and optimization algorithms that can evaluate many thousands of subjects or scenarios in a consistent and reproducible manner, using feature spaces and decision criteria that are impractical for manual processing.

In one embodiment, server uses a multi-task neural network to compute both ability index and state index from shared lower-layer features, reducing redundant computation and improving generalization. The network is trained using joint loss functions combining mean squared error for ability prediction and cross-entropy for state classification. This architecture allows server to update weights using backpropagation through both tasks simultaneously, which speeds up training convergence and reduces overfitting. In the runtime system, shared feature extraction layers avoid redundant passes over the same raw data, improving processing throughput.

In another embodiment, server applies rule-based postprocessing over the candidate placement plans that is specific to the technical environment. For example, for factory workers, server applies rules limiting maximum walking distance, enforcing required safety coverage, or satisfying maintenance windows. For sports players, server applies formation constraints (number of defenders, midfielders, forwards) or playing time regulations. These rules integrate algorithmically with the outputs of the generative AI model; server treats the model outputs as proposals and then performs algorithmic verification and repair using deterministic algorithms. This hybrid design, combining machine-learned models and rule-based logic, constitutes an unconventional technical solution that yields more precise and constraint-compliant assignments than either component alone.

Server can be implemented in various configurations. In one configuration, a single physical server hosts the database, the feature extraction models, and the prompt generation logic, while the generative AI model is accessed as a remote service over a network. In another configuration, a cluster of servers is used, with one server dedicated to ingesting sensor data and performing image processing, another server running neural network inference for indices, and a third server responsible for prompt generation, generative AI interaction, and plan synthesis. Terminal can be a workstation, a handheld device, or a wall-mounted panel on a factory floor. In some embodiments, terminal performs part of the feature extraction, such as running a lightweight model for preliminary emotion recognition, and transmits only summarized state information to server, thereby reducing network bandwidth usage.

User interacts with the system primarily through terminal. User views visualization information and can adopt or modify candidate placement plans. When user modifies a plan, terminal sends structured modification data to server, which records the adjustments and treats them as feedback signals. Server can use such feedback to retrain or fine-tune the neural networks that map feature data to indices, or to adapt heuristics for prompt generation, thereby improving the quality of subsequent recommendations. In this way, the system continuously improves its internal mappings between sensor-level data, feature data, indices, prompt sentences, and generative outputs, which further distinguishes the system from static rule-based automation.

The described embodiments can be varied without departing from the scope of the claims. For example, server can use alternative neural architectures such as graph neural networks for relational data between subjects, or can employ different loss functions tailored to ranking tasks instead of regression. Server may further incorporate uncertainty estimates for ability and state indices and encode such uncertainty in the prompt sentences, instructing the generative AI model to consider confidence values when proposing placement plans. Server can also support different technical domains beyond factories and sports, such as healthcare staffing or control room operator scheduling, by adjusting the feature extraction modules and rule sets while maintaining the same overall pipeline of feature computation, prompt sentence generation, generative AI invocation, and structured plan synthesis.

Through these configurations and operations, the system as implemented by server, terminal, and sensing devices achieves technical effects including improved processing speed due to optimized feature pipelines, improved evaluation accuracy through learned indices and multi-task neural architectures, reduced communication load by transmitting indices instead of raw data, and reduced human dependence on ad hoc prompt design by programmatically generating prompt sentences tied to underlying data structures.

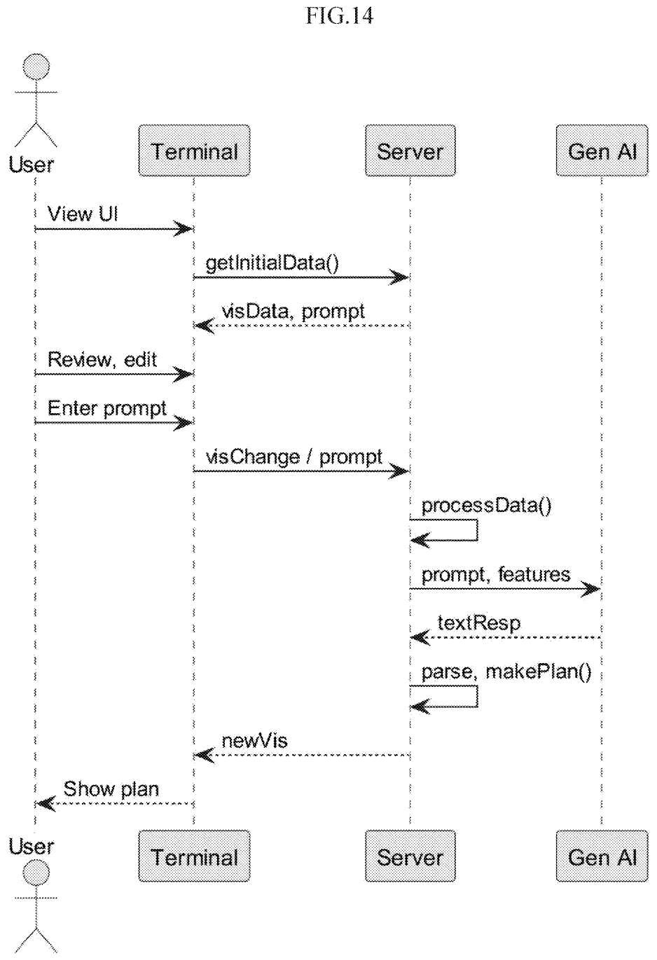

The following describes the processing flow using FIG. 14.

### Step 1:

Server acquires raw behavior information and state information.
Server receives, as input, sensor data from one or more sensing devices, including video streams from cameras, motion logs from motion sensors, and, optionally, physiological or environmental sensor readings. Server also receives, as input, facial images and audio signals forwarded from terminal. Server decodes the video streams, extracts individual frames, and time-stamps all incoming data. Server outputs synchronized raw data records, each record including a time stamp, a subject identifier (if available), and the corresponding raw image, motion, and state-related signals.

### Step 2:

Server generates motion tracks and action events from the raw data.
Server takes, as input, the synchronized raw data records from Step 1. Server applies an image processing library and a trained detection model to each frame to detect the subject's body and face, assigns or updates a track identifier for each detected subject, and computes positional coordinates for each time stamp. Server further analyzes temporal differences between consecutive positions to compute velocity, acceleration, and path segments, and uses rule-based or learned classifiers to label action events such as “pick”, “place”, “shot”, “pass”, or “inspection”. Server outputs motion track data and action event data, each entry containing the subject identifier, time stamps, spatial coordinates, and event labels.

### Step 3:

Server derives preliminary state features including emotion and fatigue indicators.
Server receives, as input, the motion track data and facial image data from Steps 1 and 2.
Server applies a convolutional neural network to each facial image to classify emotion categories and to assign confidence scores, and aggregates these scores over time to form an emotion profile for each subject. Server analyzes motion track data to detect patterns indicative of fatigue, such as reduced average speed, increased idle periods, or increased movement variability. Server combines the emotion profile and motion-based fatigue indicators by computing statistical measures such as means, variances, and trend slopes.
Server outputs state feature records, each record including emotion category frequencies, stress indicators, and fatigue indicators for each subject.

### Step 4:

Server converts behavior and state information into normalized feature data.
Server takes, as input, the motion track data, action event data, and state feature records from Steps 2 and 3. Server aggregates these data over a defined analysis window (for example, one shift or one match) and computes numerical descriptors, such as average cycle time, number of successful actions, error counts, distance covered, and aggregated emotion scores. Server normalizes each descriptor using pre-computed scaling parameters (for example, mean and standard deviation estimated from training data), aligns temporal sequences to fixed lengths, and, if necessary, reduces dimensionality using techniques such as principal component analysis implemented in a numerical computation library. Server outputs a feature vector for each subject, where each feature vector is a fixed-length numerical array representing consolidated behavior information and state information.

### Step 5:

Server calculates an ability index and a state index from the feature data.
Server receives, as input, the subject-specific feature vectors from Step 4. Server loads trained neural network models stored in memory, including a feedforward network for ability estimation and, optionally, a multi-task network with an additional branch for state estimation. Server performs forward propagation by multiplying the feature vectors by weight matrices, adding biases, and applying non-linear activation functions layer by layer. Server computes an ability index such as an efficiency or performance score and computes a state index such as a stress or fatigue score for each subject. Server writes these indices into an index table and outputs ability index records and state index records, each record being associated with the corresponding subject and time period.

### Step 6:

Server prepares structured summaries for prompt generation.
Server takes, as input, the ability index records, state index records, and, optionally, task or role requirement information stored in a configuration database. Server forms structured summaries that include, for each subject, the ability index, the state index, and selected raw or derived features such as key performance indicators. Server also constructs a list of tasks, roles, or stations, each with required ability thresholds, maximum allowable state index (for example, maximum fatigue), and other constraints. Server outputs summary objects, each summary object containing a compact representation of subject indices and task requirements for subsequent prompt sentence creation.

### Step 7:

Server generates a prompt sentence for the generative AI model.
Server receives, as input, the summary objects from Step 6. Server selects a prompt template according to the current application context, such as a factory placement context or a sports scouting context. Server fills variable portions of the template with values extracted from the summary objects, and concatenates them into a coherent natural-language instruction. For example, server generates a prompt sentence such as: “You are a production planner. Based on the following worker efficiency scores, fatigue scores, and station requirements, generate an optimal placement plan and explain your reasoning.” or “Based on the last three seasons'data, evaluate the potential of players under 20 and recommend the top 5 with explanations.” Server outputs the completed prompt sentence together with the associated summary data as a prompt package.

### Step 8:

Server submits the prompt package to the generative AI model and obtains an analysis result.
Server takes, as input, the prompt package from Step 7. Server formats the prompt sentence and summary data into a request payload compatible with a generative AI model API and sends the payload via the communication interface to a remote or local generative AI engine.
Server receives, as output, a text response that contains analysis results, including narrative evaluations of each subject and candidate placement suggestions or selection recommendations. Server stores the raw text response for logging and further processing, and outputs the text response as an intermediate analysis result.

### Step 9:

Server parses and structures the generative AI model's output into candidate placement plans.
Server receives, as input, the text response from Step 8. Server applies parsing rules, pattern matching, and, if needed, a lightweight natural-language parser to extract specific information such as subject identifiers, recommended roles or stations, ranking orders, and justifying reasons. Server converts each extracted recommendation into a structured record, including a subject identifier, a recommended assignment or ranking position, and reference to explanatory text. Server optionally evaluates the recommendations against domain-specific constraints (for example, capacity limits per station or formation rules) and applies a repair or adjustment algorithm when necessary. Server outputs one or more candidate placement plans, each plan being a set of subject-assignment pairs with associated metadata.

### Step 10:

Server generates visualization information from indices and candidate plans.
Server takes, as input, the ability index records, state index records, and candidate placement plans from Steps 5 and 9. Server constructs data structures suitable for visual representation, such as tables of subjects with indices and recommended assignments, graphical layouts of workstations or team formations, and time-series plots of scores. Server associates each subject-assignment pair with color codes or icons indicating ability and state levels. Server outputs visualization information as formatted data, including table data, chart definitions, and explanatory text, for transmission to terminal.

### Step 11:

Terminal presents the visualization information and the underlying prompt sentence to the user.
Terminal receives, as input, the visualization information and the corresponding prompt sentence from Step 10. Terminal renders the visualization on its display using its graphical library, showing, for example, for a factory embodiment, a list of workers with efficiency and fatigue scores and their suggested station assignments, and for a sports embodiment, a list of players with ability scores and their recommended roles or rankings. Terminal also displays the prompt sentence used in generating the analysis, so that user can understand how the generative AI model was instructed. Terminal outputs a user interface state that includes selectable controls for accepting, rejecting, or modifying candidate placement plans and for entering additional prompt sentences.

### Step 12:

User reviews the visualization information and optionally modifies or requests refinement.
User views, as input, the information displayed on terminal in Step 11. User interprets the candidate placement plans and their associated indices and explanations. User may decide to accept a plan as-is, to modify individual assignments (for example, by selecting a different station for a particular worker), or to request a refined analysis. When requesting refinement, user enters, as output, an additional prompt sentence via a text input field, such as: “Given the current efficiency and fatigue indexes, generate an alternative placement that reduces fatigue, even if overall throughput decreases slightly.” or “From the current shortlist, recommend three players who best fit a high-pressing, fast-transition style. Explain your choice using their data.”

### Step 13:

Terminal transmits user selections and additional prompt sentences to server.
Terminal receives, as input, the explicit user actions and any additional prompt sentence from Step 12. Terminal encodes accepted or modified assignments as structured messages, including identifiers of affected subjects and new assignments, and attaches the additional prompt sentence when provided. Terminal sends these messages to server through the communication interface. Terminal outputs request data that instructs server either to update the current placement plan based on user modifications or to perform a new analysis based on the additional prompt sentence.

### Step 14:

Server updates plans or performs re-analysis based on user input.
Server takes, as input, the request data from Step 13. If the request only includes modifications, server updates the stored placement plan records and logs the changes as feedback data. If the request includes an additional prompt sentence, server combines this user-specified prompt sentence with up-to-date feature data, ability indices, and state indices, forming a new prompt package. Server then repeats Steps 7 through 9 using the updated prompt package, generating refined analysis results and updated candidate placement plans. Server outputs updated candidate placement plans and revised visualization information, which terminal can display to user in the same manner as in preceding steps.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

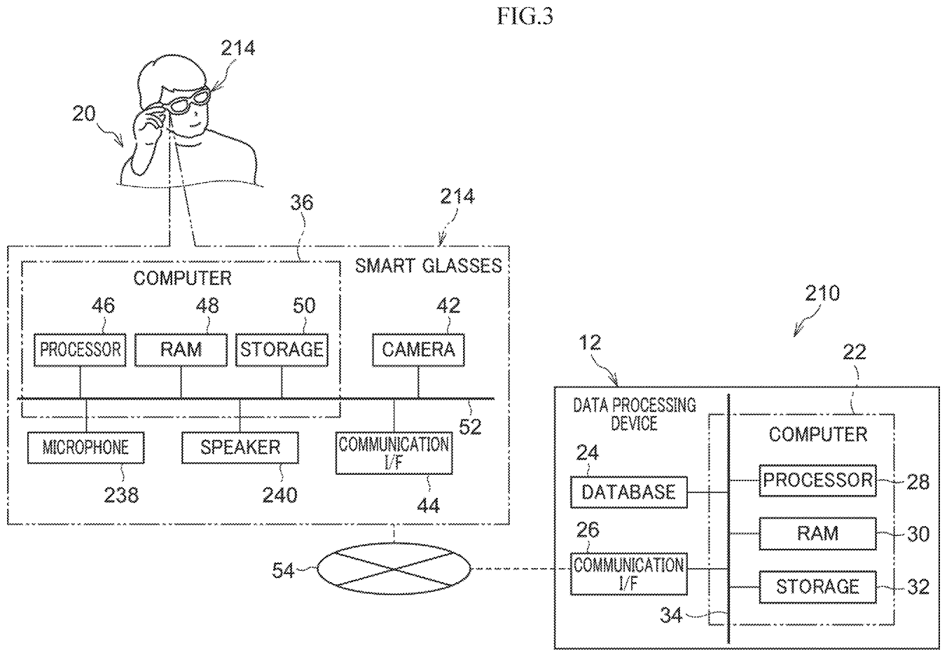

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

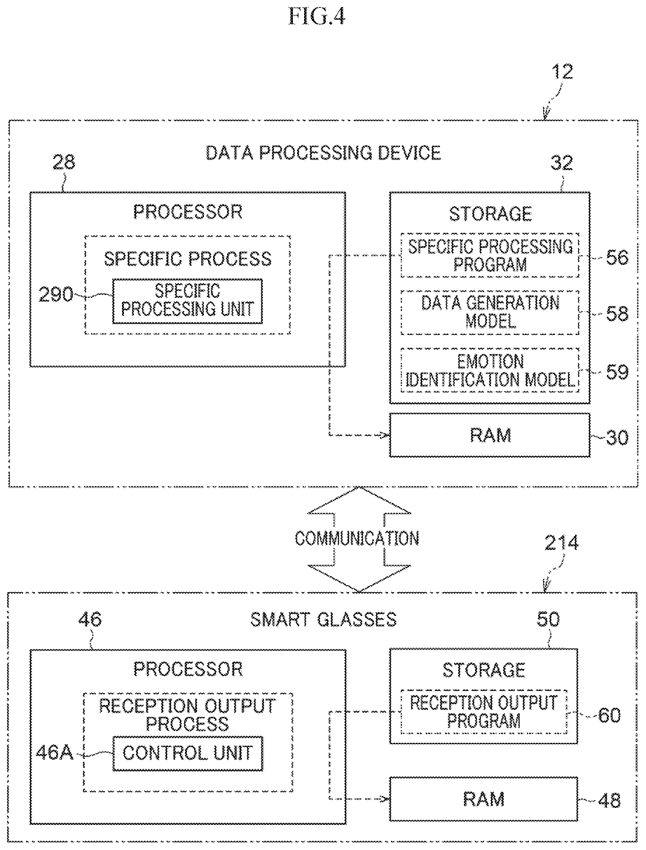

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

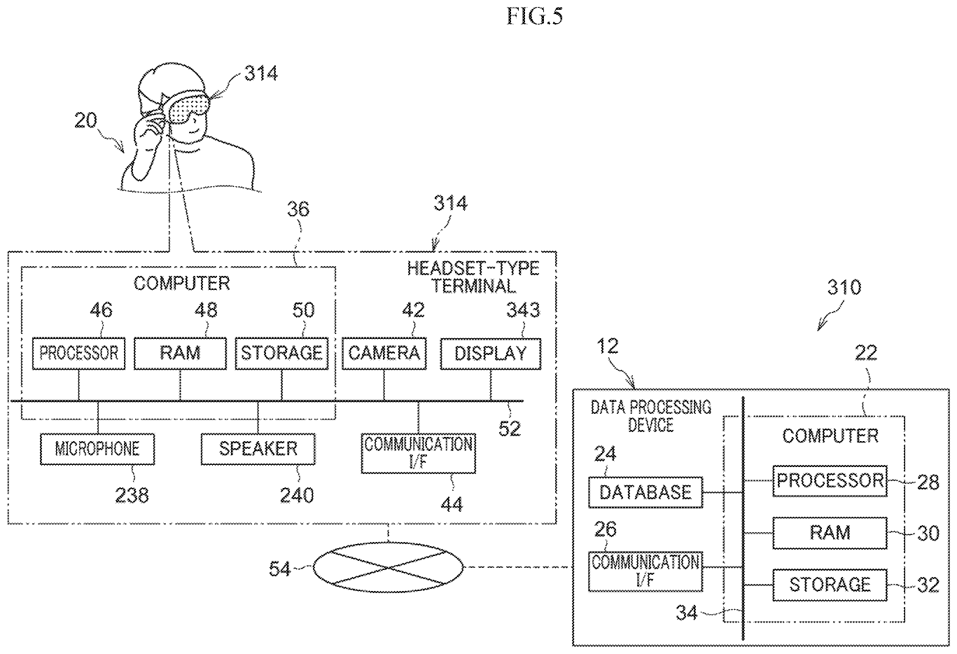

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

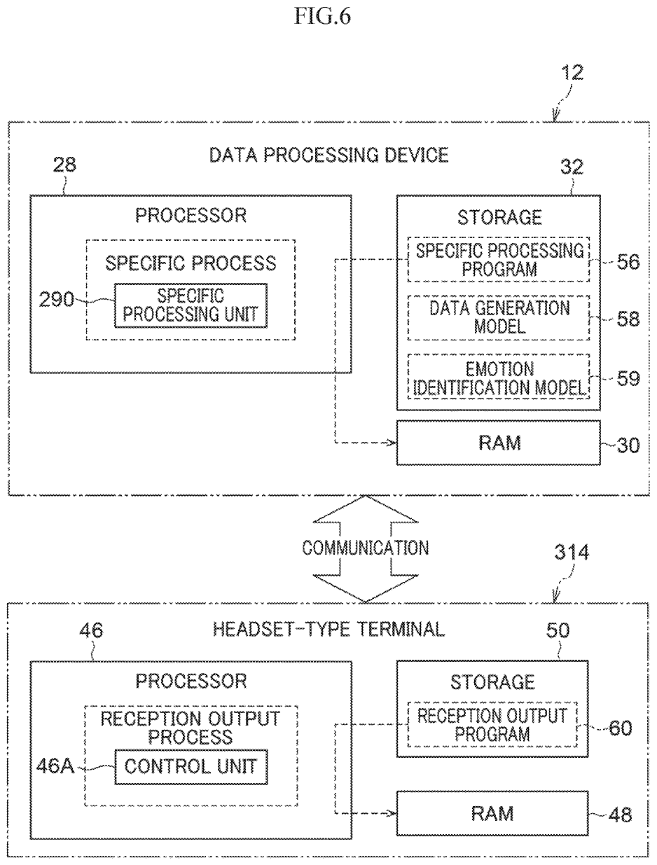

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

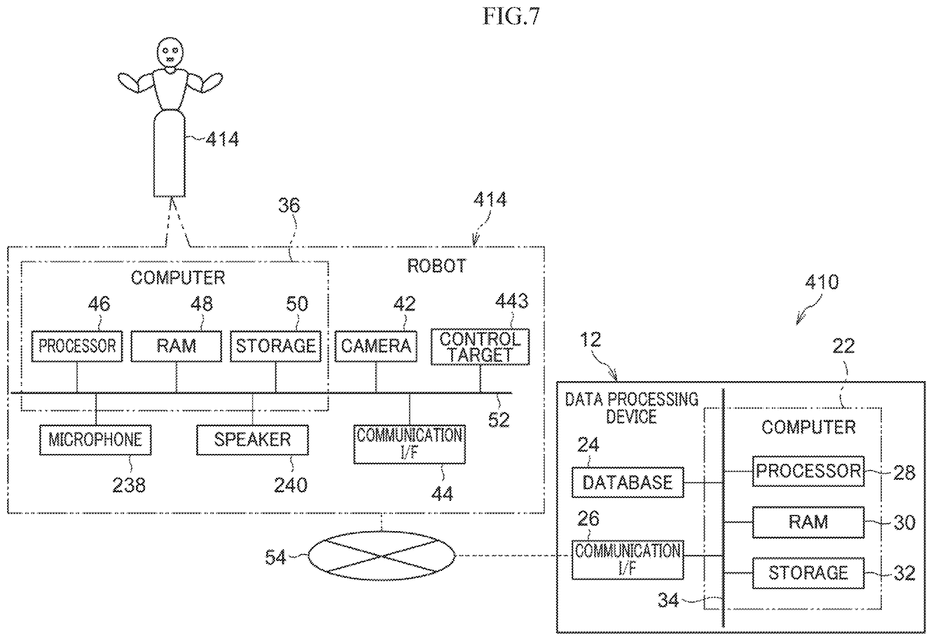

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

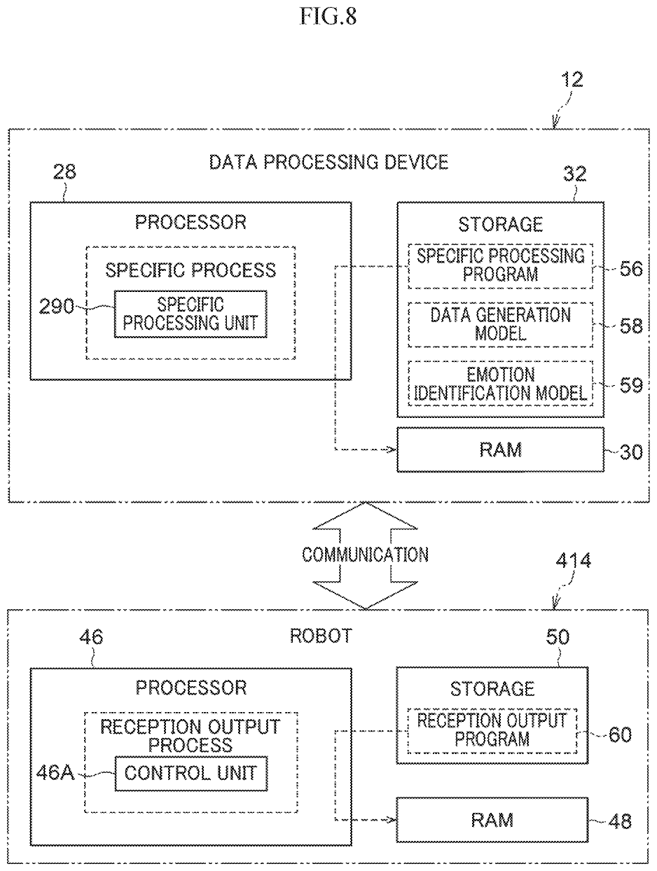

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

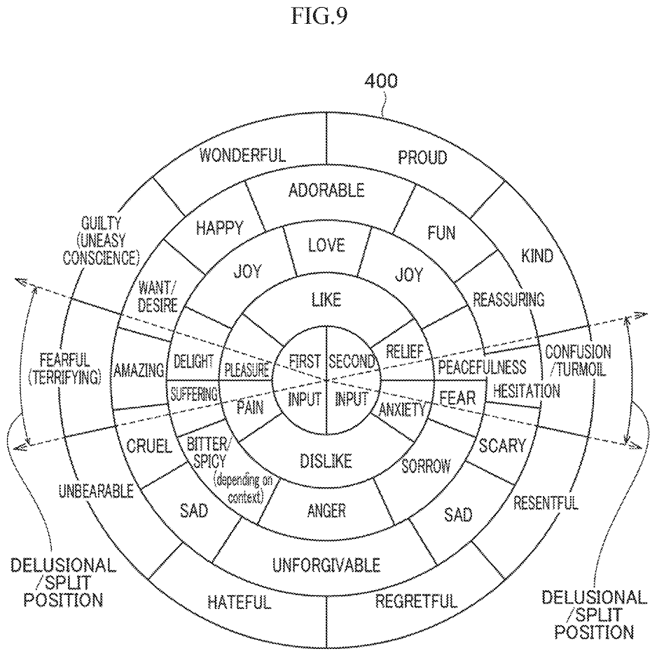

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

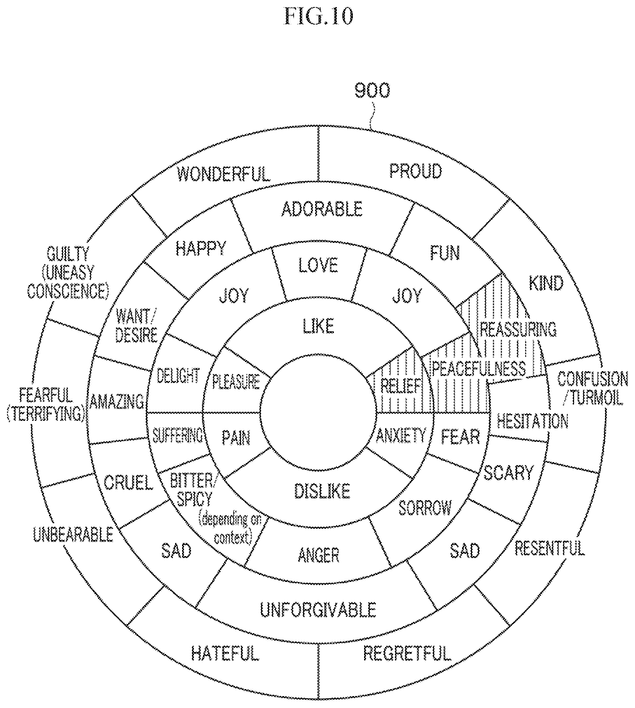

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire participant information related to a competitive activity from an external information source and store the participant information in a storage device,
perform preprocessing on the participant information stored in the storage device, the preprocessing including missing-value completion, normalization, aggregation, and encoding, and generate structured feature sets including numerical feature sequences and time-series feature sequences,
extract pixel information from image information included in the participant information, perform feature extraction processing using the pixel information, and generate feature sets corresponding to the image information,
generate a prompt sentence that instructs a generative artificial intelligence model to perform performance-evaluation computation and preference-degree computation based on the structured feature sets and the feature sets corresponding to the image information, input the prompt sentence and the feature sets into the generative artificial intelligence model, and cause the generative artificial intelligence model to generate evaluation information of the participants,
select a candidate group of participants based on the evaluation information, rank the candidate group, generate visualization information including the candidate group and the evaluation information, and transmit the visualization information to a terminal device, and associate a query prompt sentence generated in response to input from a user with the evaluation information, re-input the query prompt sentence and the evaluation information into the generative artificial intelligence model, cause the generative artificial intelligence model to generate explanatory information and recommendation information for assisting decision-making of the user, and provide the explanatory information and the recommendation information to the terminal device.

### (Supplementary 2)

The system according to supplementary 1,
wherein the processor is configured to
generate, for each participant, a plurality of numerical evaluation values including a current-performance index, a future-growth index, and a role-suitability index based on the structured feature sets and the feature sets corresponding to the image information that are input to the generative artificial intelligence model, generate a composite evaluation index by combining the numerical evaluation values, generate a prompt sentence that instructs the generative artificial intelligence model to generate the evaluation information using the numerical evaluation values and the composite evaluation index, and cause the generative artificial intelligence model to generate the evaluation information by using the prompt sentence.

### (Supplementary 3)

The system according to supplementary 1,
wherein the processor is configured to
generate integrated input information by combining a query prompt sentence received from the user with the evaluation information and the candidate group of participants, input the integrated input information to the generative artificial intelligence model, cause the generative artificial intelligence model to generate response information including candidate reselection, ranking modification, and rationale explanation according to conditions specified by the user, and update and present the candidate group of participants based on the response information.

### Application Example 1

### (Supplementary 1)

A system comprising a processor,
wherein the processor is configured to
acquire operation data and image information of a plurality of targets, associate the operation data and the image information with each other along a time series, and store the associated data in a storage,
divide the image information into image units, extract feature values from the image units and the operation data, generate preprocessed data, and evaluate performance and suitability of each target by inputting the preprocessed data into a machine learning model, perform a clustering calculation on the evaluation results of the machine learning model to group the plurality of targets, and for each group perform ranking based on suitability for predetermined tasks to generate candidate arrangement plans,
generate input information including structured data comprising the candidate arrangement plans and the evaluation results, and a prompt sentence that instructs analysis content of the structured data and presentation content of an optimal arrangement plan, input the input information into a generative AI model, and acquire response information including explanation information and improvement proposals regarding the candidate arrangement plans, and
present arrangement candidates and recommended arrangements of the targets to a user based on the response information and the candidate arrangement plans, receive selection of a final arrangement from the user, and output the selection result as arrangement information.

### (Supplementary 2)

The system according to supplementary 1,
wherein the processor is configured to
statistically aggregate performance indices, safety indices, and suitability indices over a predetermined period from the evaluation results of the machine learning model for each target to generate quantified evaluation results, and provide the quantified evaluation results as part of the structured data to the generative AI model, thereby causing analysis using a prompt sentence that instructs the generative AI model to perform capability evaluation of the targets and validity evaluation of the arrangement plans.

### (Supplementary 3)

The system according to supplementary 1,
wherein the processor is configured to
re-evaluate the candidate arrangement plans based on recommended arrangements and explanation information included in the response information from the generative AI model and on constraint information and preference information acquired from the user, update and present the arrangement candidates of the targets according to a re-evaluation result, and generate a prompt sentence that instructs additional analysis by the generative AI model regarding the updated arrangement candidates, and perform the additional analysis using the prompt sentence.

### Example 2

### (Supplementary 1)

A system comprising a processor,
wherein the processor is configured to acquire behavior information and viewing information regarding subjects, store the behavior information and the viewing information as structured information in a storage device, and perform information organization processing including information format checking and missing-value processing on the structured information,
extract attribute information and numerical information from the organized structured information, perform normalization processing on the numerical information and encoding processing on the attribute information to generate feature information, input the feature information to a trained evaluation model executed on a machine learning computation resource, calculate numerical evaluation information for each subject, and store the numerical evaluation information in association with each subject in the storage device,
extract a candidate subject group that satisfies selection conditions including a role condition, an age condition, and a performance condition based on the numerical evaluation information and the attribute information, and generate candidate subject list information in which the candidate subject group is ranked according to the numerical evaluation information, receive, from an operation terminal, a prompt sentence including a natural-language query, input the prompt sentence to a generative AI model including a generative language model, obtain structured condition information representing selection conditions inherent in the prompt sentence, and search the candidate subject group from the storage device by using the structured condition information, and
transmit the candidate subject list information corresponding to the searched candidate subject group to the operation terminal, and present the candidate subject list information on a user display screen of the operation terminal to support operations of comparison and selection by a user.

### (Supplementary 2)

The system according to supplementary 1,
wherein the processor is configured to
convert the structured condition information output from the generative AI model into query control information including evaluation-criterion information, sorting-condition information, and extraction-limit information, and dynamically control search processing and ranking processing on the numerical evaluation information and the attribute information based on the query control information to generate the candidate subject list information.

### (Supplementary 3)

### The System According to Supplementary 1,

wherein the processor is configured to
obtain emotional adjustment information generated by an emotion processing function that calculates emotion-state information, based on the numerical evaluation information and a search result obtained from the structured condition information output from the generative AI model, correct priorities of the candidate subject group by using the emotional adjustment information, generate the candidate subject list information, and input, to the generative AI model, a prompt sentence including an evaluation instruction for presenting the candidate subject list information so as to obtain supplementary explanation information, and provide the supplementary explanation information to the operation terminal together with the candidate subject list information.

### Application Example 2

### (Supplementary 1)

A system comprising a processor,
wherein the processor is configured to
acquire and store behavior information and state information of a subject, preprocess the behavior information and the state information and convert the behavior information and the state information into feature data in order to calculate an ability index and a state index of the subject,
generate a prompt sentence that instructs a generative AI model to perform evaluation of the subject or to generate a placement plan based on the feature data and at least one of the ability index and the state index, and input the prompt sentence and at least one of the feature data, the ability index, and the state index into the generative AI model to cause the generative AI model to execute analysis processing,
generate an ability evaluation result of the subject and one or more candidate placement plans by using an analysis result output from the generative AI model, and present the one or more candidate placement plans as a plurality of options, and
output visualization information including the analysis result and the one or more candidate placement plans, and provide support information that adopts or modifies at least a part of the one or more candidate placement plans in response to instruction input from a user.

### (Supplementary 2)

The system according to supplementary 1,
wherein the processor is configured to
treat the behavior information as including motion information and image information of a worker or a player,
treat the state information as including emotion information or fatigue information,
generate the prompt sentence such that the prompt sentence instructs the generative AI model to generate an ability evaluation score of the subject and a placement plan in consideration of the feature data and at least one of the emotion information and the fatigue information, and
generate the visualization information such that the visualization information includes the ability evaluation score, at least one of the emotion information and the fatigue information, and the placement plan in a format that allows mutual comparison.

### (Supplementary 3)

The system according to supplementary 1,
wherein the processor is configured to
control a terminal device to display the visualization information,
receive, via the terminal device, a user input of an additional prompt sentence that instructs the generative AI model to perform additional analysis or to generate an alternative placement plan,
cause the generative AI model to execute analysis processing again based on the additional prompt sentence, and
update and present the one or more candidate placement plans according to a result of the analysis processing executed again.

What is claimed is:

1. A system comprising:
circuitry configured to:
acquire participant information related to a competitive activity from one or more external information sources via a communication interface coupled to a packet-switched network, and store the participant information in a memory;
perform preprocessing on the participant information stored in the memory, the preprocessing comprising missing-value completion, normalization, aggregation, and encoding, and generate structured feature sets comprising numerical feature sequences and time-series feature sequences;
extract pixel information from image information included in the participant information, perform feature extraction processing using the pixel information, and generate feature sets corresponding to the image information;
generate a prompt sentence that instructs a generative AI model to perform performance-evaluation computation and preference-degree computation based on the structured feature sets and the feature sets corresponding to the image information, input the prompt sentence and the feature sets to the generative AI model, and cause the generative AI model to generate evaluation information of participants; and
select a candidate group of participants based on the evaluation information, rank the candidate group, generate visualization information comprising the candidate group and the evaluation information, and transmit the visualization information to a terminal device via the communication interface.

2. The system according to claim 1, wherein the circuitry is configured to associate a query prompt sentence generated in response to input from a user with the evaluation information, re-input the query prompt sentence and the evaluation information to the generative AI model, cause the generative AI model to generate explanatory information and recommendation information for assisting decision-making of the user, and transmit the explanatory information and the recommendation information to the terminal device.

3. The system according to claim 2, wherein the circuitry is configured to generate integrated input information by combining the query prompt sentence with the evaluation information and the candidate group, input the integrated input information to the generative AI model, cause the generative AI model to generate response information comprising candidate reselection, ranking modification, and rationale explanation, and update the candidate group based on the response information.

4. The system according to claim 3, wherein the circuitry is configured to generate a plurality of candidate query prompt sentences by varying at least one of a constraint parameter or a comparison target, present the candidate query prompt sentences to the user via the terminal device, and accept a selection from the user to determine the query prompt sentence.

5. The system according to claim 4, wherein the circuitry is configured to record an execution log comprising each query prompt sentence, the corresponding response information, and the updated candidate group, and store the execution log in the memory for audit and reproducibility.

6. The system according to claim 1, wherein the circuitry is configured to generate, for each participant, a plurality of numerical evaluation values comprising a current-performance index, a future-growth index, and a role-suitability index based on the structured feature sets and the feature sets corresponding to the image information, generate a composite evaluation index by combining the numerical evaluation values, and include the numerical evaluation values and the composite evaluation index in the prompt sentence.

7. The system according to claim 6, wherein the circuitry is configured to apply a weighted combination to the current-performance index, the future-growth index, and the role-suitability index to generate the composite evaluation index, wherein the weights are adjustable parameters stored in the memory.

8. The system according to claim 1, wherein the feature extraction processing applied to the pixel information comprises applying a convolutional neural network to extract spatial feature maps from the image information, and the feature sets corresponding to the image information comprise feature vectors derived from the spatial feature maps.

9. The system according to claim 1, wherein the preprocessing further comprises applying sliding window aggregation to the time-series feature sequences to generate statistical summary features, and applying encoding to categorical attributes of the participant information.

10. The system according to claim 1, wherein the circuitry is configured to perform a clustering calculation on the evaluation information to group participants, and for each group perform ranking based on suitability for a predetermined task category to generate candidate arrangement plans included in the visualization information.

11. The system according to claim 10, wherein the clustering calculation applies a distance-based algorithm to the numerical evaluation values to generate cluster assignments, and the candidate arrangement plans are generated by ranking participants within each cluster based on the composite evaluation index.

12. The system according to claim 1, wherein the circuitry is configured to apply emotion recognition processing to sensor data received from the terminal device to generate an emotion label, and adjust at least one parameter of the prompt sentence based on the emotion label to generate an emotion-adjusted evaluation output.

13. The system according to claim 12, wherein the circuitry is configured to adjust a ranking weight applied to the composite evaluation index based on the emotion label, and regenerate the candidate group using the adjusted ranking weight.

14. The system according to claim 1, wherein the structured feature sets are generated by associating the participant information with time-series data along a time axis, dividing the time-series data into fixed-length segments, and extracting numerical feature sequences from each segment.

15. The system according to claim 1, wherein the circuitry is configured to normalize the structured feature sets by applying z-score normalization or min-max normalization to each feature dimension prior to input to the generative AI model.

16. The system according to claim 1, wherein the visualization information comprises a ranked list of participants with associated evaluation scores and a graphical representation of performance trends derived from the time-series feature sequences.

17. The system according to claim 16, wherein the circuitry is configured to update the visualization information in response to a user modification to a ranking criterion received from the terminal device, and transmit the updated visualization information to the terminal device via the communication interface.

18. A system comprising:
circuitry configured to:
acquire participant information from one or more external information sources via a communication interface, store the participant information in a memory, and perform preprocessing comprising missing-value completion, normalization, and encoding to generate structured feature sets and image-derived feature sets;
generate a prompt sentence incorporating the structured feature sets and the image-derived feature sets, input the prompt sentence to a generative AI model to generate evaluation information, and select and rank a candidate group of participants based on the evaluation information;
transmit visualization information comprising the candidate group and the evaluation information to a terminal device; and
receive a query prompt sentence from the terminal device, re-input the query prompt sentence and the evaluation information to the generative AI model to generate explanatory information and recommendation information, and transmit the explanatory information and the recommendation information to the terminal device.

19. The system according to claim 18, wherein the circuitry is configured to generate numerical evaluation values comprising a current-performance index, a future-growth index, and a role-suitability index, compute a composite evaluation index by combining the numerical evaluation values, and include the composite evaluation index in the prompt sentence.

20. A method comprising:
acquiring participant information related to a competitive activity from one or more external information sources via a communication interface coupled to a packet-switched network, and storing the participant information in a memory;
performing preprocessing on the participant information stored in the memory, the preprocessing comprising missing-value completion, normalization, aggregation, and encoding, and generating structured feature sets comprising numerical feature sequences and time-series feature sequences;
extracting pixel information from image information included in the participant information, performing feature extraction processing using the pixel information, and generating feature sets corresponding to the image information;
generating a prompt sentence that instructs a generative AI model to perform performance-evaluation computation and preference-degree computation based on the structured feature sets and the feature sets corresponding to the image information, inputting the prompt sentence and the feature sets to the generative AI model, and causing the generative AI model to generate evaluation information of participants; and
selecting a candidate group of participants based on the evaluation information, ranking the candidate group, generating visualization information comprising the candidate group and the evaluation information, and transmitting the visualization information to a terminal device via the communication interface.
